(19) United States
(12) Patent Application Publication
(10) Pub. No.: US 2016/0301539 A1
(43) Pub. Date: Oct. 13, 2016

(54) BROADCAST IN MESHED NETWORKS

(71) Applicant: TELEFONAKTIEBOLAGET L M ERICSSON (PUBL), Stockholm (SE)

(72) Inventors: Bengt LINDOFF, Bjarred (SE); Magnus ASTROM, Lund (SE)

(21) Appl. No.: 14/901,491

(22) PCT Filed: Oct. 10, 2014
(86) PCT No.: PCT/EP2014/071773

§ 371 Date: Dec. 28, 2015

(51) Int. Cl. H04L 12/18; H04L 12/721; H04W 40/12; H04W 40/20; H04W 4/06

(52) U.S. Cl. CPC H04L 12/1881; H04W 40/20; H04W 4/06; H04W 40/12; H04L 45/124; H04W 84/18

(57) ABSTRACT

A method for handling broadcast packets, in a wireless device participating in a wireless ad hoc network.

### TECHNICAL FIELD

Embodiments herein relate to a wireless device, and a method therein. In particular, it relates to the wireless device relaying broadcast packets when in a wireless ad hoc network.

### BACKGROUND

Mobile communications networks are normally multi-purpose networks providing communication capabilities for a variety of communication devices. Mobile communication networks are typically managed by a telecom operator.

The communication devices are also known as wireless devices, wireless terminals, mobile terminals, mobile stations, user equipment (UE), etc. These words can typically be regarded as synonyms, but some of them are also in some contexts used to denote a communication device in relation to a specific telecom standard, but the latter aspect is not of importance in this application. Wireless devices are enabled to communicate wirelessly in a cellular communications network or wireless communication system, sometimes also referred to as a cellular radio system, cellular network or mobile telephony network. The communication may be performed e.g. between two wireless devices, between a wireless device and a regular fixed telephone and/or between a wireless device and a server via a Radio Access Network (RAN) and possibly one or more core networks, comprised within the cellular communications network.

Wireless devices may further be referred to as user equipments, mobile telephones, cellular telephones, laptops, tablet computers or surf plates with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another wireless device or a server.

The cellular communications network covers a geographical area which is divided into cell areas, wherein each cell area being served by an access node. A cell is the geographical area where radio coverage is provided by the access node.

The access node may e.g. be a base station such as a Radio Base Station (RBS), eNB, eNodeB, NodeB, B node, or BTS (Base Transceiver Station), depending on the technology and terminology used. The base stations may be of different classes such as e.g. macro eNodeB, home eNodeB or pico base station, based on transmission power and thereby also cell size.

Further, each access node may support one or several communication technologies. The access nodes communicate over the air interface operating on radio frequencies with the wireless devices within range of the access node. In the context of this disclosure, the expression Downlink (DL) is used for the transmission path from the access node to the wireless device. The expression Uplink (UL) is used for the transmission path in the opposite direction i.e. from the wireless device to the access node.

In 3rd Generation Partnership Project (3GPP) Long Term Evolution (LTE), access nodes, which may be referred to as eNodeBs or even eNBs, may be directly connected to one or more core networks.

3GPP LTE radio access standard has been written in order to support high bitrates and low latency both for uplink and downlink traffic. All data transmission is in LTE is controlled by the radio base station.

An ad hoc network is put together for a specific purpose and are often, but not always, of a temporary nature. (Ad hoc is Latin and means “for this purpose”.) Ad hoc network sometimes refer to any set of networks where the nodes/devices have equal status in the network and are free to associate with any other node/device in link range. Sometimes these nodes/devices are referred to as ad hoc nodes/devices.

A wireless ad hoc network is a decentralized type of wireless network were the nodes/devices communicates wirelessly. Sometimes these nodes/devices are referred to as wireless nodes/devices or even wireless ad hoc nodes/devices. The network is referred to as ad hoc because it does not rely on a preexisting infrastructure, such as base, stations, access points or routers, which are normally present in managed (infrastructure) wireless networks like mobile telephony networks. Instead, each node/device participates in routing by forwarding data for other nodes/devices. The determination of which nodes/devices should forward data to which other nodes/devices is made dynamically on the basis of network connectivity. In addition to the classic routing, ad hoc networks can use a flooding technique for forwarding data. Flooding is traditionally a simple algorithm where every incoming packet is sent on every outgoing link except the one it arrived on (when having multiple links). In a wireless ad hoc network it could be implemented by each node/device simply retransmitting all incoming packets, in order to relay them to other nodes/devices.

A MANET (mobile ad hoc network) is a self-configuring infrastructure-less network of nodes/devices that are mobile and wirelessly connected. Sometimes these nodes/devices are referred to as mobile nodes/devices or even mobile ad hoc nodes/devices. Each node/device in a MANET is free to move independently in any direction, and will therefore change its links to other devices frequently. Each device must forward traffic unrelated to its own use, and therefore be a router. The primary challenge in building a MANET is equipping each device to continuously maintain the information required to properly route traffic. Such networks may operate by themselves or may be connected to the larger Internet. A MANET is a kind of wireless ad hoc network.

A mesh network is a network topology in which all nodes/devices cooperate in the distribution of data, typically by each node/device relaying data for the network. The nodes/devices in a mesh network are sometimes referred to as mesh nodes/devices. A mesh network can be designed using a flooding technique or a routing technique. When using a routing technique, the message is propagated along a path, by hopping from node/device to node/device until the destination is reached. To ensure all its paths' availability, a mesh network must allow for continuous connections and reconfiguration around broken or blocked paths, using self-healing algorithms. Comparing the two techniques it can generally be said that the flooding technique typically generates more network traffic caused by the data transmissions, but does not generate any network traffic caused by control messages or protocols to set up routes or paths, simply since these mechanisms are not used. The routing technique on the other hand generate less network traffic caused by data transmission, but generates network traffic caused by control messages and protocols setting up routes and paths and related tasks. A mesh network whose nodes/devices are all connected to each other is a fully connected network. Mesh networks can be seen as one type of ad hoc network. MANET and mesh networks are therefore closely related, but a MANET also have to deal with the problems introduced by the mobility of the nodes/devices, while the nodes/devices in a mesh network does not necessarily have to be neither mobile nor wirelessly connected. Although mesh networks are mostly used in wireless situations, the concept is also applicable to wired networks and software interaction. The self-healing capability in a routing based mesh allows the network to continue to operate when a node breaks down or a connection goes bad. As a result, a routing based mesh network is typically quite reliable, as there is often more than one path between a source and a destination in the network. Also flooding based mesh networks are reliable due to the fact that they by default send data via different paths by retransmissions.

The terminology in this field is not totally uniquely defined, different people sometimes use different terminology for the same thing, and the same terminology for different things. For the purpose of simplicity we will use wireless ad hoc network to denote any of the above listed network types (ad-hoc network, wireless ad hoc network, MANET and mesh network). We use wireless device, device or node to denote a node/device operating in such a network. Specifically we will also use wireless device (or device or node) for communication devices that are normally operating in a mobile telephony network but that at some point temporarily, or even permanently, have lost contact with the mobile telephony network, and will start to participate in a wireless ad hoc network. Please note that wireless device (or device or node) when used in this document also covers other wireless units such as Machine to Machine (M2M) devices, smartphones, modems, laptops etc.

Although the idea of enabling D2D (device to device) communications as a means of relaying in cellular networks was proposed by some early works on ad hoc networks, the concept of allowing local D2D communications to use or re-use cellular spectrum resources simultaneously with ongoing cellular traffic is relatively new. Because the non-orthogonal resource sharing between the cellular and the D2D layers has the potential of reuse gain and proximity gain, at the same time increasing the resource utilization, D2D communications underlying cellular networks has received considerable interest in the recent years.

Specifically, in 3GPP LTE networks, LTE Direct, a type of D2D communication, can be used in commercial applications, such as cellular network offloading, proximity based social networking, or in public safety situations in which first responders need to communicate with each other and with people in a disaster area [3GPP TR 22.803].

D2D communication entities (wireless devices) using an LTE Direct link may reuse the same PRB (physical resource block), meaning the time and frequency resources, as used for cellular communications either in the downlink or in the uplink or both. The reuse of radio resources in a controlled fashion can lead to the increase of spectral efficiency at the expense of some increase of the intra-cell interference. Typically, D2D communicating entities use UL (up-link) resources such as UL PRBs or UL time slots, but conceptually it is possible that D2D communications takes place in the cellular DL (down-link) spectrum or in DL time slots.

The main reason for introducing D2D in LTE is to introduce support for NSPS (National Security and Personal Safety) services. One of the main ideas is that devices should be able to communicate with each other also when not in contact with the RAN (radio access network) either temporarily or permanently. Even if D2D communication in LTE might be able to support many services, one of the more important ones seems to be broadcast communication, typically represented by traditional “walkie-talkie” functionality. Basic D2D broadcast communication is one of the services that most likely will be introduced in the close future.

For NSPS service coverage is of major importance. It would typically be important for a group of firefighters to be able to communicate with all the firefighters in a group.

A specially interesting scenario arises when all or some of the NSPS devices loose contact with the RAN, for example being temporarily out of contact with the base stations and thus the rest of the RAN. In this scenario one can imagine that the NSPS devices form a wireless ad hoc network, which can be seen as a temporary network with the purpose of allowing the various NDPS devices to stay in contact with each other, even when not being in contact with the RAN via a base station or access point.

NSPS devices will probably be allowed to use higher TX power than current LTE devices, up to 30 dBm compared to current LTE standard supporting only 23 dBm. This will help to extend the radio coverage for an individual device. But in order to increase the coverage further, given a fixed TX power, it will probably be required to apply some kind of relaying approach. The relaying would allow NSPS devices to reach other NSPS devices, outside its own radio coverage, by using intermediate NSPS devices as relay stations forwarding traffic to NSPS devices further away. The relaying would apply to all different kinds of traffic, examples could be point to point connection oriented traffic between two specific devices, but also traditional walkie-talkie point-to-multi-point functionality directed to multiple devices, most likely implemented as broadcast traffic. Thus there is a need for an efficient relaying method for improved broadcast coverage in a wireless ad hoc network.

In existing mesh communications standards such as IEEE 802.11 Mesh and IEEE 802.15 (Zigbee) path setup is handled by either proactive or reactive signaling.

Proactive signaling normally use a root node to which all other nodes signals periodically, hence a node always knows the path to root and root always knows the path to all nodes. The periodic signaling requires significant overhead.

Reactive signaling establishes a path upon request when data is to be transmitted. At that instant the path must be found by broadcast signaling to all other nodes in the network, causing significant overhead and possible broadcast storm problems limiting the practical network size.

ISSN 1748-1279 “Area-based beaconless reliable broadcasting in sensor networks” by Fransico Ovalle-Martinez'et al discusses the use of GPS for determination of neighbors' location and for taking decisions on when to relay.

“The Broadcast Storm Problem in a Mobile Ad Hoc Network” by publisher Mobicom 1999, and author Ni et al. discusses the broadcast storm problem in ad hoc networks.

“On the Reduction of Broadcast Redundancy in Mobile Ad Hoc Networks” by IEEE Proc. MobiHoc 2000, author Peng discusses a broadcast flooding protocol, where use of the source, and relay, transmitter neighbor list is used to decide whether a broadcast should be relayed or not.

“Comparison of Broadcasting Techniques for Mobile Ad Hoc Networks” by publisher Mobihoc '02, and author Williams provides an overview of different routing algorithms, in general the addressed broadcast problem deals with initial broadcasts (ARP eller PREQ) upon which unicast traffic is initialized. Any learning is done from beacon signaling. Network pruning is explicitly done based on beacon signaling. Node distance estimation is computed from path-loss data.

“A Dialogue-based MAC Protocol for Efficient Broadcasting in Ad Hoc Networks” by Mobile and Wireless Communications Summit, 2007 Author Hasegawa propose a broadcast protocol using request/reply dialogue (i.e. feedback signaling) for Neighbour identification.

Self-Pruning Broadcasting for Mobile Ad Hoc Networks an article in “Global Telecommunications Conference, 2009. GLOBECOM 2009. IEEE ” by author Woon, Yeung discloses mechanism for reducing the collision risk of the relay transmissions by introducing delayed relay based on neighbor information.

### SUMMARY

An object of the presented disclose is to mitigate, alleviate, or eliminate one or more of the deficiencies with both flooding techniques and routing techniques by using an intelligent need-based broadcast propagation.

The invention proposes a method for broadcast transmission in a wireless ad hoc network, where each node determines whether it should relay the transmission or not based on determined information of the wireless ad hoc network.

According to some aspect this disclosure relates to a method, performed in a wireless device, for handling a first broadcast packet which first wireless device is operating in a wireless ad hoc network, the method comprising;

Receiving a first transmit packet from a second wireless device operating in the wireless ad hoc network wherein the first transmit packet comprises a first broadcast packet and a first meta data related to the first broadcast packet,

determining based on the first meta data, and a second meta data whether the first broadcast packet shall be relayed by the first wireless device to one or more third wireless devices operating in the wireless ad hoc network, and/or whether the first broadcast packet shall be decoded by the first wireless device; wherein the second meta data is related to the first broadcast packet and to the wireless ad hoc network.

An advantage with embodiments herein is that a broadcast packet is only decoded by higher layer if it is needed. Hence, the message is not repeated on application level saving power as well as enhancing the quality of the broadcast service.

Another advantage with embodiments herein is that a broadcast packet is not relayed if not needed to be relayed by the wireless device. Hence this improves the capacity of the system and reducing the risk of broadcast storms.

Another advantage with embodiments herein is that the wireless device builds up information about adjacent nodes based on earlier received broadcast packets, hence better and better decision for acting as a relay is achieved. This reduces the number of unnecessary broadcasting transmission, while still increasing the coverage of the broadcast.

Another advantage with embodiments herein is that there is no need for overhead signaling approaches, like discovery beacon transmission, or other pro-active network signaling.

In this way drawbacks of existing flooding techniques and routing techniques are mitigated.

### BRIEF DESCRIPTION OF THE DRAWINGS

Examples of embodiments herein are described in more detail with reference to attached drawings in which:

FIG. 1 is a system overview illustrating embodiments of a wireless ad-hoc network.

FIG. 2 is an overview of the relationship between broadcast messages and broadcast packets.

FIG. 3 is an overview of basic relaying of a broadcast packet.

FIG. 4 is an overview of knowledge gained while relaying, related to FIG. 3

FIG. 5 is an overview of a chain of transmit packets, carrying a broadcast packet.

FIG. 6 is a flowchart depicting embodiments of a method in a wireless device.

FIG. 7a provides an overview of a path through a wireless ad-hoc network, focusing on the Transmit Packets.

FIG. 7b provides an overview of the same path as FIG. 7a, but focusing on the First Meta Data

FIG. 7c provides an overview of the continuation of the same path as in FIGS. 7a and 7b.

FIG. 8 provides an overview of a second path through the wireless ad-hoc network.

FIG. 9 provides an overview of the First Meta Data and the Second Meta Data.

FIG. 10 is a schematic block diagram illustrating embodiments of a wireless device.

### DETAILED DESCRIPTION

Embodiments herein relates to self-organized broadcast transmission principles in a wireless ad-hoc network consisting of multiple wireless devices.

Embodiments herein provide principles for a wireless device
1. to determine whether a received broadcast packet should be decoded by the wireless device and forwarded to higher layers like e.g. the application layer for further processing, and
2. to determine whether the wireless device should relay the received broadcast packet to other wireless devices, and
3. to get a understanding/picture of the topology in the wireless ad-hoc network.

The determining is based on two sets of meta data:
A. a first meta data that is received together with the received broadcast packet
B. a second meta data that is built up locally in the wireless device, based on earlier received broadcast packets.

The wireless device will over time get an increasingly better understanding of the network topology, and will take increasingly better decisions on (making better determinations of) whether to relay received broadcast packets.

In order to cater for changes in the network topology, the wireless device will at some points revert to a state where it consider itself knowing nothing (or less) about the topology, in this state it will relay all packets and then start to build up the second meta data again from scratch (or from some intermediate state).

The wireless devices operate independently, there is no central/main node and no shared database. Each device builds up its own understanding/picture of the network topology, and make its own determinations. In order to make it possible for other wireless devices to operate according to these principles, all wireless devices has to follow common rules for how to construct and send the first meta data together with a broadcast packet.

The embodiments herein aims amongst other things at minimizing the unnecessary traffic in the wireless ad hoc network, meaning that it aims at minimizing unnecessary relaying as well as avoiding sending specific control traffic in order to detect paths.

Let's for a moment discuss in more generic terms, in order to provide a good background and to make the detailed technical discussions easier to follow. A wireless device can be said to be in a wireless environment, meaning an environment with potential wireless communication possibilities The wireless environment does not, for the sake of this description, have to be so exactly defined, it is more of a conceptual environment, e.g. comprising multiple wireless devices. The wireless environment could be said to cover a certain area, which does not have to be so strictly defined either. A wireless device might not be able to communicate directly, or via relaying, with some or all of the other wireless devices. In fact some wireless device might not be able to communicate with any other wireless device. The wireless environment may comprise a wireless ad hoc network at some point in time, it might in fact comprise multiple wireless ad hoc networks as well, and it might not contain any wireless ad hoc network at all.

If looking at a wireless ad hoc network in the wireless environment discussed above, the wireless ad hoc network can be said to comprise the wireless devices that have the possibility to communicate with each other through broadcast transmissions. Another way of expressing that the wireless devices have the possibility to communicate with each other though broadcast transmissions would be to say that they are in radio coverage of each other directly or via relaying, yet another way would be to say that they are in direct or indirect range of each other. Analogously a wireless device that is in direct radio coverage of one or more other wireless devices in a wireless ad hoc network could be said to be in range of the wireless ad hoc network or in radio coverage of the wireless ad hoc network.

For the purpose of this application the wireless ad hoc network does not depend on any connection oriented type of communication in order to be defined as a wireless ad hoc network, it is sufficient that the devices are in direct or indirect range of each other. It is of course easy to imagine an implementation where wireless devices that are in range of each other are not allowed to communicate with each other. One such example could be a case where a groups of fire fighters, or a group of policemen would not like people outside the group to be able to listen in on, and/or participate in, the voice conversations or other traffic. Mechanisms, for creating and keeping track of groups and/or permissions to communicate between wireless devices are outside the scope of this application. Thus In order to follow the description in this application it is sufficient to imagine a basic implementation where all wireless devices that are in direct or indirect range of each other are allowed to communicate with each other.

The wireless environment is not necessarily static, some wireless devices can for example move around and thus go temporarily, or permanently, out of radio coverage of a specific wireless ad hoc network. A wireless device may also move to a different position, causing it to communicate via a different wireless device than before in order to reach the other wireless devices in the selected wireless ad hoc network.

The dynamics can cause the picture to be quite complicated, one such example is when a wireless device, that are participating as a critical path node (meaning a node that provides the only way of communication between two nodes or two groups of nodes) is in a wireless ad hoc network, moves and goes out of radio coverage of one or more other wireless devices participating in the same wireless ad hoc network. This could break up the original wireless ad hoc network and cause the forming of multiple smaller wireless ad hoc networks that are isolated from each other. It is a matter of definition whether one of the above mentioned small wireless ad hoc networks is a “smaller version” of the previously existing larger network, or whether they are completely different networks.

In the wireless ad hoc network described above, different wireless devices can be the originating device. Assume that the wireless devices would be personal communication devices belonging to a fire fighter crew, in this example different members of the fire fighter crew could be using a walkie-talkie like functionality causing transmission of broadcast packets to be originated by their personal devices.

If taking a look at the case when one specific wireless device is the originating device of a specific broadcast packet, one could follow the propagation of that broadcast packet through the wireless ad hoc network. The broadcast packet may take many different paths (or routes) through the wireless ad hoc network, in order to reach all the recipients. It may also take more than one path from the initiating device to one specific wireless device, meaning that the broadcast packet may be received multiple times by the selected receiving device. In fact the originating device will in some cases itself receive the broadcast packet it just created and sent out, when it is being relayed by a unit close by.

A wireless ad hoc network WAHN can be regarded as being in different states. These states, referring to the entire wireless ad hoc network, are more conceptual states introduced in order to help understanding the embodiments herein. There is not necessarily any specific knowledge in any individual node, or shared between nodes, that indicate or reflect these states directly.

The WAHN initial state. Assume a situation where a number of wireless devices has just lost contact with a telecommunication network, for the sake of simplicity imagine that they will not move around and that there are no other things that will change the radio coverage, the wireless environment can in this way be regarded as static. In the moment they lose contact they become independent wireless devices, they do not necessarily have any knowledge about other wireless devices in the surrounding wireless environment. They could be in radio coverage of other wireless devices, and they could even have the possibility to reach wireless devices even further away by means of relaying, but they are typically not aware of these possibilities, at least not initially, this state could be referred to as the WAHN initial state. Assume for simplicity that a group of wireless devices are within radio coverage of at least one other device in such a way that they can all communicate with each other through broadcast transmission using relaying. While being in this state one could claim that no wireless ad hoc network really exists since the wireless devices have not yet necessarily any knowledge of each other. Theoretically one could also claim that a wireless ad hoc network exists, especially if the devices are in radio coverage of each other as described above. This distinction is more of a theoretical nature and is not so important for understanding the embodiments herein. Let us for the sake of simplicity claim that the wireless ad hoc network exists (even though the wireless devices might not be aware of this fact yet), another way of expressing it would be to say that they form a “potential” wireless ad-hoc network.

The WAHN learning state. As soon as one wireless device, being the originating device, starts to transmit broadcast packets, one or more other wireless devices will receive these broadcast packets, the wireless devices receiving the broadcast packets will relay them in order to reach other wireless devices, typically also causing the initiating device to receive one or more of the relayed packets. When receiving the broadcast packets the wireless devices starts to know about each other. This state could be referred to as the WAHN learning state. When other wireless devices, at other points in time, act as originating devices more and more broadcast packets will propagate between the devices taking different paths. In this way more and more devices will know about each other and about the topology of the wireless ad hoc network.

WAHN stable running state. At some point the wireless devices will have sent a sufficient amount of broadcast packets from one or more initiating devices in order for the nodes to build up sufficient information about the topology of the wireless ad hoc network in order to avoid unnecessary relaying. At this point the wireless ad hoc network could be regarded as being in the WAHN stable running state. An illustrating example would be that a wireless device in the outmost fringes would be aware that it, in some cases, does not need to relay a broadcast packet since there are no wireless devices beyond itself, relying on the wireless device to relay the broadcast packet. (More cases will be discussed further on in this application.)

WAHN rediscovery state. Now we should introduce the possibility of wireless devices to move around, or for other events to happen that could cause the change of radio coverage. In order to take into account things like:
Firstly when a wireless device goes out of coverage of the other wireless devices in the wireless ad hoc network.
Secondly when a wireless device (after a time long enough to have been perceived as out of coverage by the other wireless devices in the wireless ad hoc network) returns into coverage of the other wireless devices in the wireless ad hoc network, or when a “new”, previously unknown wireless device comes within coverage of one or more of the wireless devices in the wireless ad hoc network.
Thirdly when a wireless device move to a position where it is still in contact with the wireless ad hoc network, but having to communicate via a different wireless device than earlier.

In order for the wireless ad hoc network to adapt to changes like for example the ones listed above, the wireless ad hoc network now and then has to try to find out if any connections has changed, if devices has moved, if devices has gone out of coverage, if new devices has come into coverage, etc.

The state when the entire wireless ad hoc network, or parts thereof, is trying to find out if the connectivity has changed can be referred to as WAHN rediscovery state.

After being in the WAHN rediscovery state for a while the wireless ad hoc network will typically go back to the WAHN stable running state. The wireless ad hoc network will then typically go back and forth between these two states in order to continue to detect, and adapt to, changes in connectivity.

Depending on the implementation a variety of events could cause the wireless ad hoc network to enter the WAHN rediscovery state. Examples of such events could be, but are not limited to, the expiration of one or more timers, the reception or transmission of a certain amount of broadcast packets, the reception of broadcast packets from a specific unit.

The states of a wireless ad-hoc network discussed above, are more of conceptual states. Each participating wireless device acts independently, and builds up its own knowledge about the surrounding wireless environment and any wireless ad hoc networks present, and each participating wireless device also make its own decisions on when to relay or not, and on when to decode or not.

The wireless devices have corresponding states, which typically are real states that are kept track of in the wireless devices. A wireless device typically starts in a less enlightened state, at this point the device does not know which other devices are in the wireless neighborhood, which ones can be reached and which wireless ad-hoc networks are present, this state would be referred to as the Initial State. The other corresponding states would be referred to as the Learning State and the Stable Running State. In some embodiments there exists a Re-discovery state, in other embodiments the wireless device would simply go back from the Stable Running State to the Initial State or the Learning State, or from the Learning State to the Initial State. In some embodiments only a non-relaying wireless device will go to a re-discovery state (alternatively to the Initial State or Learning State), in other embodiments all wireless devices will go through this transition. Typically a wireless device being in the re-discovery state would send one or more relays that it would not consider necessary. Imagine a wireless device in the fringes of the wireless ad-hoc network. When in the stable running state it would have learned that it does not have to relay broadcast packets from some originating devices. When going to the re-discovery state it would relay those broadcast packets anyways, in order to be able to detect if new devices has come in coverage, or if other changes has taken place. Devices will individually go to re-discovery state (or change states according to the other descriptions above). These changes of states could e.g. be triggered either by a timer, or by reception of a certain number of packets, or by reception of a certain sequence number, etc.

When using a timer, the starting time is called time event TE1, at that time a first timer is started, and the first timer would run for some time (called the time period TP1) until it is triggered indicating that it is time to change to re-discovery state. At that time this new time instance is called time event TE1, the first timer is restarted and runs for a new time period TP1 until the first timer is triggered again, and so on.

There is no direct correspondence between the conceptual states of the network and the states of the wireless devices, and this application does not aim at clarifying or defining any specific detailed mapping between the two. The networks states are simply there to help understand the behavior of the equipment on a system or overview level, while the states of the wireless devices are tightly connected to the invention.

One very high level approach to mapping could be to think of the Wireless Ad-Hoc Network as:
1. being in the WANH Initial State when all participating wireless devices are in the Initial State
2. being in the WAHN Learning State when at least one participating device is in the Learning State
3. being in the WAHN Stable Running State when all participating wireless devices are in the Stable Running State.
4. The WANH Rediscovery State would reflect a Wireless Ad-Hoc Network where at least one participating Wireless Device are in the Re-discovery State (or has changed in other ways described above).
5. Please note that this is not an exact mapping, it is just a conceptual mapping intended to help getting started to understand the invention. One can easily imagine a case when all wireless devices in a wireless ad-hoc network change from Stable Running State to Initial State. It can then be discussed whether the network would be in WAHN Initial State or WAHN Rediscovery State. But such discussions are to a great part academic and are not directly useful for understanding this application.

The states of the wireless devices will be elaborated on further down in this application.

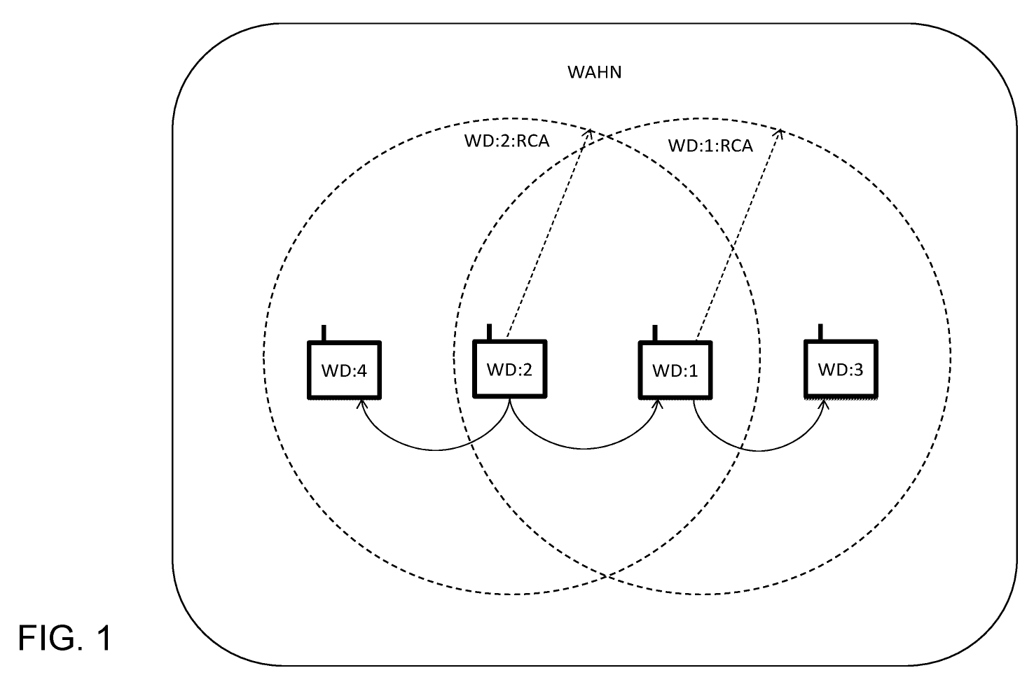

FIG. 1 depicts an example of a wireless ad-hoc network WAHN according to a first scenario in which embodiments herein may be implemented. The wireless ad hoc network comprises a plurality of wireless devices, exemplified in the figure by the four wireless devices WD:1, WD:2, WD:3 and WD:4.

In a wireless ad-hoc network all wireless devices might not be in radio coverage of all other wireless devices, meaning that a specific wireless device may not be able to successfully receive radio signals sent by another specific wireless devices. This is illustrated in FIG. 1 by showing the radio coverage area WD:1:RCA of the first wireless device WD:1, and the radio coverage area WD:2:RCA of the second wireless device WD:2. As is shown in the figure the third wireless device WD:3 is outside the radio coverage area of the second wireless device WD:2. This would mean that the second wireless device WD:2 can't communicate directly with the third wireless devices WD:3. Instead the second wireless device WD:2 would typically have to communicate via the first wireless device WD:1. This is the cause of the need to relay broadcast packets.

The wireless devices WD:1, WD:2, WD:3 and WD:4 in the wireless ad-hoc network may be of different kinds, e.g. two of the wireless devices in the figure may be mobile phones and two may be computers, any other configuration is of course also possible.

The wireless devices WD:1, WD:2, WD:3 and WD:4 may communicate with each other using different kinds of wireless radio communication technologies.

In order to explain embodiments herein in a simple way please assume the following illustrating example. Imagine a squad of firefighters that has temporarily lost contact with the Radio Access Network. The firefighters might be working in a larger building or area and still would desire to be able to contact each other, via their communications equipment, using walkie-talkie like speech calls intended for all fire-fighters or maybe firefighters belonging to a specific group. To do that it would be necessary to communicate directly between their wireless devices without the aid of a base station or an access point. Thus it would be necessary to form a wireless ad-hoc network. Walkie-talkie like speech communications may be implemented as broadcast messages. Since all pieces of communications equipment might not be in radio coverage of all other pieces communications equipment it would most likely be necessary to relay the broadcast packets.

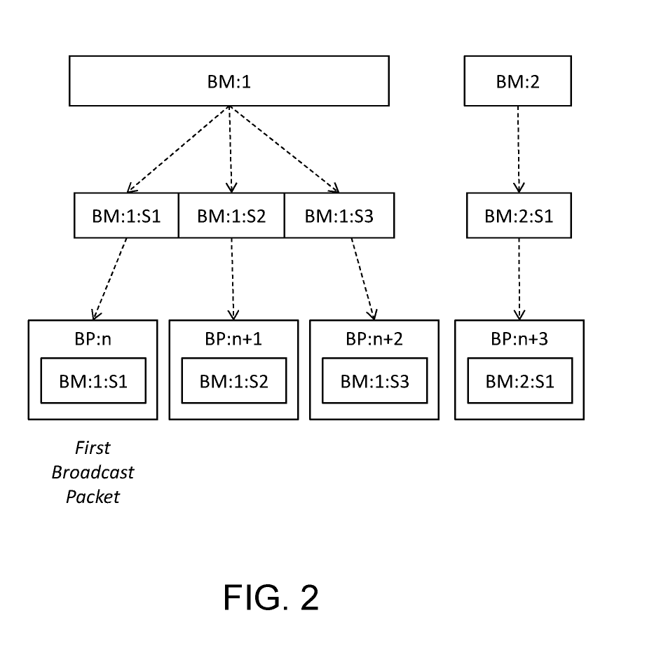

FIG. 2 depicts two different typical examples of broadcast messages, BM:1 and BM:2, and how they will be segmented and put into broadcast packets for transmission through the wireless ad-hoc network WAHN according to a scenario in which embodiments herein may be implemented. In telecommunication and information theory broadcasting refers to a method of transferring a message, let's call it a broadcast message, to all recipients simultaneously or near simultaneously. In computer networking broadcasting refers to transmitting a packet that is intended to be received by every device in the network. Both of these similar terms are relevant for the scenarios discussed herein.

Starting with the broadcast messages, the first broadcast message BM:1 could represent a walkie-talkie like voice message sent by a firefighter in the scenario discussed above. The firefighter presses the speech button and talks, the wireless device records what he says and sends it out as a broadcast message. Typically the voice message will be longer than a the packet size used by wireless ad-hoc network, this means that the broadcast message BM:1 would have to be divided into segments. In our example, the broadcast message would be divided into three segments BM:1:S1, BM:1:S2 and BM:1:S3. These segments would then be put into broadcast packets, in the example, BP:n, BP:n+1 and BP:n+2. The broadcast packets are then ready for transmission. In a typical implementation the recording, segmentation, packaging and transmission would to a large extent be done in parallel, meaning that the first segments would be transmitted while the firefighter is still talking and the wireless device is recording the voice message.

The second broadcast message BM:2 may represent a control message, e.g. something sent from one of the wireless devices to the rest, conveying some sort of system information, it could e.g. be related to synchronisation of clocks, or it could be information about which frequencies to use in the future. The second broadcast message BM:2 would typically be small enough to fit within the packet size used by the ad-hoc network. This means that it may be represented by one single segment BM:2:S1, and that it would be put into one single broadcast packet BP:n+3. In a typical implementation many broadcast messages that together would fit into one broadcast packet may be concatenated and sent together in a broadcast packet. Also other kinds of packaging including splitting up, concatenating and/or rearranging segments in order to best utilise the broadcast packets might of course be possible.

The sender of broadcast packets typically does not wait for, or in any other way depend on, specific acknowledgements from the recipients, indicating successful reception of the packets.

Broadcast packets were traditionally sent from one device to all the recipients in one transmission. In the wireless ad-hoc network the broadcast will however depend on relaying, each wireless device WD:1, WD:2, WD;3 and WD:4 will according to specific rules relay broadcast packets.

The rest of this document will focus on the broadcasting of one single broadcast packet BP:n. The wireless device that creates the broadcast packet and makes the first transmission of that broadcast packet can be said to be the originating device, of that specific broadcast packet. The originating device could also be referred to as the initiating device or the device that originates a broadcast transmission or the device that initiates a broadcast transmission.

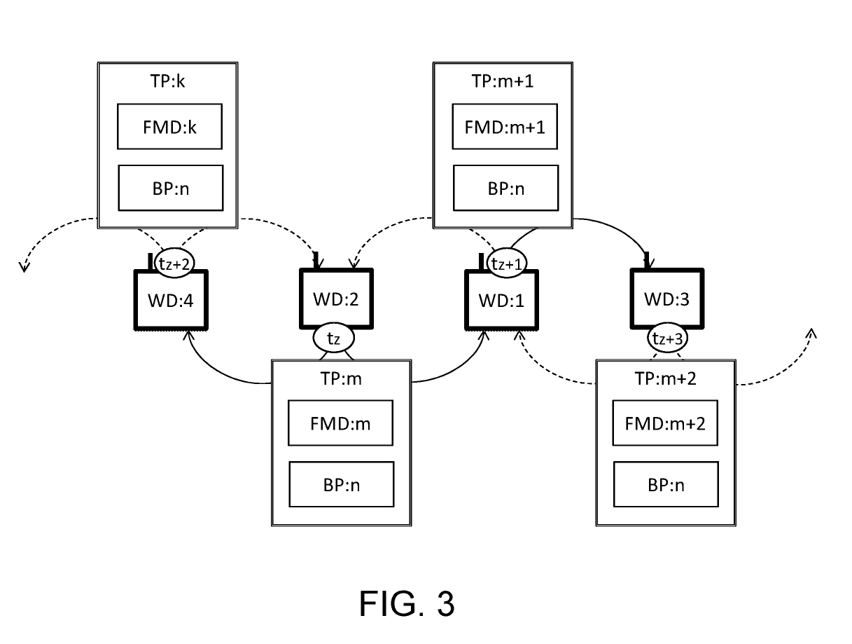

FIG. 3 depicts the relaying of a broadcast packet BP:n, in an example scenario in which embodiments herein may be implemented. (In order to simplify the description below, the radio coverage areas from FIG. 1 is assumed to be valid, but are not explicitly showed in FIG. 3.)

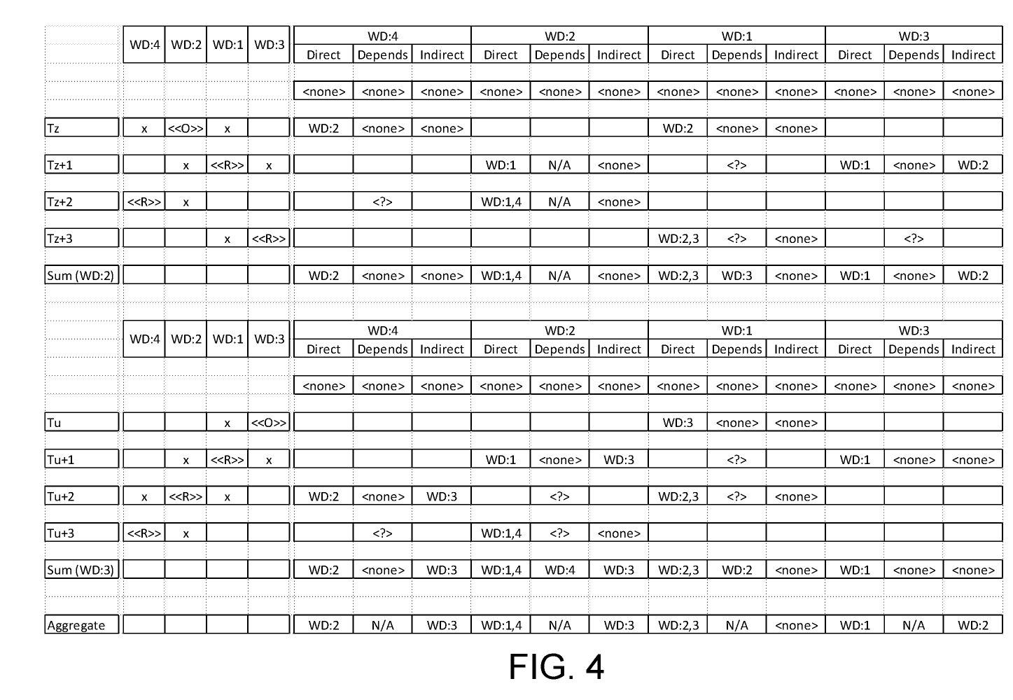

(Please also refer to FIG. 4, and the text describing FIG. 4.)

Since the embodiments herein focus on that the individual wireless devices learn in which cases they should broadcast the broadcast packet and in which cases it is not necessary, lets first take a look at what would happen when the wireless devices has not learned anything yet. It is easy to imagine that in an initial state they do not know which devices are in the wireless neighbourhood or part of the wireless ad-hoc network WAHN. Each device can be said to be in an initial state, not having received any transmit packet yet, thus not having started to build up knowledge about the wireless ad-hoc network WAHN.

As soon as a wireless device starts receiving transmit packets it could be said to enter a learning state, building up information and gradually taking more and more enlightened decisions on whether to relay a packet or not. The description below aims at showing the main components of a gradual transition from the initial state, through the learning state to a stable running state. It also presents the main rules for taking the decisions.

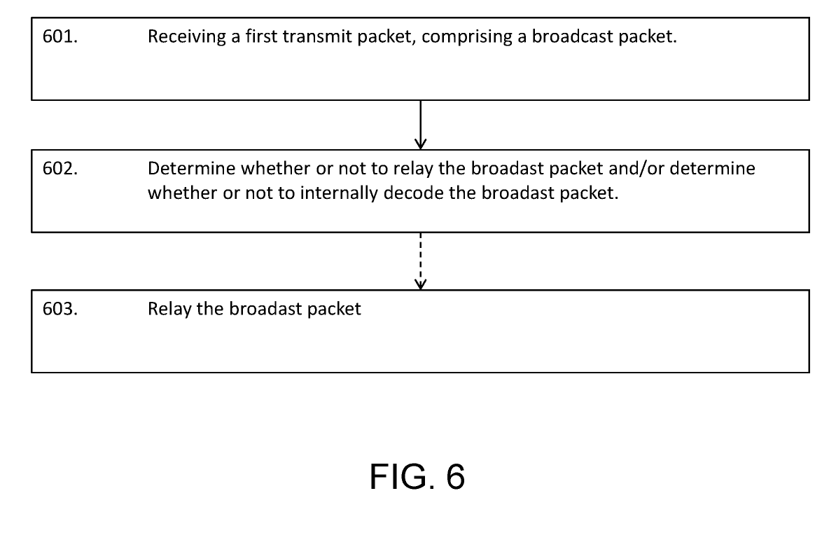

At time t_{z} the second wireless device WD:2 transmits a broadcast packet BP:n to all recipients within its radio coverage area WD:2:CA. The transmission is done as follows; the broadcast packet BP:n is being put inside a transmit packet TP:m, together with a first meta data FMD:m, and the entire transmit packet TP:m is then transmitted. This first meta data is related to the broadcast packet PB:n and its path through the wireless ad hoc network WAHN. A first set of parameters typically states the Id of the originating device, IdOD, and a sequence number, SN, related to the originating device, these parameters will remain the same during the propagation of the broadcast packet BP:n, via different paths through the wireless ad hoc network, WAHN. The first meta data FMD:m also contains a second set of parameters that reflect the specific path it has taken when arriving at a wireless device. As will be discussed further down in this document (e.g. when discussing FIG. 6a) a broadcast packet can arrive at a wireless device through different paths. Typically the first set of parameters like the Id of the originating device IdOD, and the sequence number SN will be used by the receiving device to identify which broadcast packet it is, whether it is the first time it is received by the wireless device or whether it has possibly been received before through another path. and the second set of parameters will be used to get information on the path the broadcast packet has taken and which wireless devices the broadcast packet has been relayed by on that specific path. In some embodiments the second set of parameters could contain information only on the immediately preceding wireless device, in other embodiments it could contain information about one or more additional preceding wireless devices. Specifically in picture three the second set of parameters would typically reflect that it is sent from the second wireless device WD:2 and it also in some embodiments reflect the history it has before being sent from the second wireless device WD:2, Please note that the transmission made by the second wireless device WD:2 may have been a broadcast originating from the second wireless device WD:2, but it may also have been a relaying of a broadcast packet that the second wireless device WD:2 did received from another wireless device. In the description below related to FIG. 3, we assume that the second wireless device WD:2, is the device that has originated the broadcast packet (unless otherwise specifically stated) for the sake of simplicity.

The transmission from the second wireless device WD:2 is received by the first wireless device WD:1 as well as a fourth wireless device WD: 4. It does however not reach the third wireless device WD:3. It is thus desirable that the first wireless device WD:1 relays the broadcast packet PB:n in order to reach the third wireless device WD:3.

At time t_{z+1} the first wireless device WD:1 relays the broadcast packet BP:n, by transmitting an updated transmit packet TP:m+1 to all recipients within its radio coverage area WD:1:CA. The updated transmit packet TP:m+1 contains the first broadcast packet PB:n, together with an updated first meta data FMD:m+1. The first set of parameters in the first updated first meta data FMD:m+1 are identical to the corresponding parameters in the first meta data FMD:m, the Id of the originating device and the sequence number related to the originating device are the same. The second set of parameters are however updated in order to reflect that it now is sent from the first wireless device WD:1 and it also could in some embodiments also reflect earlier history (it may for example now also reflect that it has been sent by the second wireless device WD:2 before being sent by the first wireless device WD:1, and in some embodiments also contain information about even earlier history, thus keeping information about the path it has taken through the wireless ad-hoc network WAHN.) The transmit packet TP:n+1, is received by the third wireless device WD:3 and the second wireless device WD:2.

At time t_{z+2}, in analogy with the above, the fourth wireless device WD:4 will transmit a transmit packet TP:k which will be received by the second wireless device WD:2. (This transmit packet uses the index k since it is not in the path of the first wireless device, which transmit packets in this document use the indices m−2, m−1, m, m+1, m+2 etc.)

At time t_{z+3}in analogy with the above, the third wireless device WD:3 will send transmit packet TP:m+2, which will be received by the first wireless device WD:1.

The description above reflects very much what would happen in a wireless ad-hoc network when in the WAHN initial state. If analysing the transmissions it can be seen that only two of the transmissions are really necessary in order to reach all devices, namely the ones made at time t_{z} and t_{z+1}. Below it will be discussed how the wireless devices teach themselves how to make more efficient use of the available bandwidth and not make unnecessary transmissions. In the embodiments herein a wireless device starts learning about the wireless ad-hoc network WAHN as soon as it starts receiving transmit packets. The learning will be gradual, increasing when passing the Learning State and be improved when reaching the stable running state.

The things a device will learn are:
1. When to decode the broadcast packet contained in the transmit packet. (For use in the device, in case of a voice message the decoding could e.g. mean that data from the broadcast packet is used as input to a voice-decoder, and that the output is fed to speakers or headphones).
   a. The goal is that all different received broadcast packets BP:n, BP:n+1, BP:n+2, etc. shall be decoded, but that data shall not be duplicated (no broadcast packet shall be decoded more than once).
   b. The conceptual rule is that a broadcast packet, shall be decoded the first time it is received (unless it is a relay of a broadcast packet originating from the wireless device itself then it shall not be decoded), and it shall not be decoded in any potential subsequent receptions.
   c. The rules according to some embodiments are described in action 602, under the text referring to the FIG. 6.
2. When to relay the broadcast packet and when not to forward the broadcast packet.
   a. The goal is that all wireless devices in the wireless ad-hoc network shall receive the broadcast packet, but that unnecessary relays shall be avoided.
   b. The conceptual rule is that a broadcast packet, shall be relayed the first time it is received, if the device knows/suspects that other wireless devices are depending on the wireless device to relay the broadcast packet (unless it is a relay of a broadcast packet originating from the wireless device itself then it shall not be relayed), and it shall not be decoded in any potential subsequent receptions. Here one also has to consider that the determination on when to relay a broadcast packet also depends on who is the originating device (besides of course if the wireless device itself was the originating device).
   c. The rules according to some embodiments are described in action 602, under the text referring to the FIG. 6.
3. To get a good picture of the wireless ad-hoc network and the comprised wireless devices and the existing connections (which wireless devices can communicate with which other wireless devices).
   a. The goal is that a wireless device shall get sufficient knowledge about the wireless ad-hoc network to be able to make correct decisions on whether it is necessary to decode and/or relay a received broadcast packet.
   b. It is a side effect that the wireless devices also can build up a more or less accurate picture of the wireless devices that at WAHN stable running state comprises the wireless ad-hoc network. By changing the rules slightly (e.g. increasing the number of preceding devices that are included in the First Meta Data) the wireless devices could be provided more or less information, allowing them to get a more or less accurate picture of the wireless devices, and the ways they can communicate. One example where such information could be useful is to imagine the members of a firefighter crew to be able to see, e.g. on the screen of their communication devices, which other wireless devices are currently in coverage of the wireless ad-hoc network. Allowing the person to understand who will receive his broadcast messages, and also to understand if some of his colleagues are not currently in coverage.

Here one has to consider that the embodiments described herein are based on that the various wireless devices implements the same (or nearly identical) logic for when to relay a received broadcast packet and which information to send in the First Meta Data. Some parameters have to be provided in order to make the idea work, some others (like for example information about the preceding devices might vary, as long as it is implemented in a clear way preventing misunderstandings).

Concerning minimising the risk of collisions of the transmit packet (containing the broadcast packet). In order to minimise the risk for collision it is desirable to avoid that two devices are transmitting simultaneously on the same resources.

Let's first focus on only the time aspect and as an example take a look at what would happen when the first wireless device WD:1 and the fourth wireless device WD:4 receive the first transmit packet TP:m which was transmitted by the second wireless device WD:2. In a case when both the first and fourth wireless devices shall relay the broadcast packet, it is desirable that they do not make the transmission of the transmit packets at the same time (meaning that the times t_{z+1} and t_{z+2} are separated with at least the transmission duration which may be in the order of one millisecond, i.e. one sub frame, taking the LTE D2D communication mode as an example). This could for example be achieved by the wireless devices introducing a small randomized delay in each device, and since the introduced randomized delays will be different in the two devices, the transmissions will then occur at different times. In some embodiment a CSMA/CA approach is used but also other randomized transmission schemes may be envisioned. One could envision randomized delays based on pseudo random numbers, based on selection from a set of delay values, based on the randomization of the address of the wireless device to transmit and based on the path loss from the previous transmitting wireless device, also other randomizations could be used. The delay is small however, in the order of milliseconds. The time/frequency resources used for transmission may be based on pre-configured information, e.g. determined from a pre-defined standard.

In some embodiment the randomization may not only be in time but in frequency as well. Utilizing that the pre-configured resources to be used for broadcast transmission in some cases may be a subset of the entire system bandwidth, and that the broadcast message (a typical service is Voice) is small compared to the capacity in the frequency domain. Hence two different wireless devices may be able to relay the same message during, almost, the same time instance but on different orthogonal frequency resources. The advantage of such f/t resource scheduling randomization is that the total time delay from source transmission to last relay transmission may be much shorter and at the same time reducing the risk for collisions as in case same frequency resources have been used by all devices). Different f-domain randomization schemes may be envisioned, for instance;
Based on pseudo random numbers pointing out first sub-carrier Resource block to start transmit on
First sub-carrier Resource Block to use based on device identity and a look up table

In some embodiment “wrap around” is possible, i.e. parts of the message is transmitted on the opposite side of the pre-configured frequency bandwidth. In yet another embodiment, the device may select a frequency domain resource slot by identifying unused resource blocks.

By applying the rules in this application to the situation discussed above, the third wireless device WD:3 and the fourth wireless device WD:4, will learn in which cases they will need to relay the broadcast packet, and in which cases they will not.

FIG. 4 displays the transmissions (like the ones discussed in FIG. 3) on the left side, and the gained knowledge on the right side. The gained knowledge will be stored in the wireless devices where it is relevant.

The uppermost table corresponds to FIG. 3 (the broadcast packet is originated by the second wireless device WD:2).

The mid table shows a corresponding table for the case when a broadcast packet would have been originated by the third wireless device WD:3, in order to highlight that different knowledge would be gained when receiving broadcast packets from different originating devices.

The first two tables should be read as follows: the left most column of each table shows the time. The next four columns shows the transmission. The top row contains the device names, the rows under contains what happens at different times (the first row reflects the initial state). For example at time t_{z}, the second wireless device WD:2 originates a broadcast packet (shown by the symbol <<O>>), which is received by the fourth wireless device WD:4 and the first wireless device WD:1 (shown by the symbol x). At time t_{z+1} the first wireless device WD:1 is relaying the broadcast packet (shown by the symbol <<R>>), etc. The remaining rightmost columns shows the knowledge that each wireless device has about other wireless devices, which wireless devices it can receive broadcast packets from directly without any need for relaying (and thus most likely transmit broadcast packets to directly), which wireless devices can it receive traffic from indirectly and which wireless devices depends on the selected wireless device to relay the broadcast packet. Examples could be that short after the time t_{z} when the first wireless device WD:1 and the fourth wireless devises WD:4 have received the transmit packet TP:m transmitted by the second wireless device WD:1, they will know about the second wireless device, they will also know that they can be received directly by the second wireless device WD:2. Other examples could be that short after t_{z+1} the second wireless device will know about the first wireless device. And short after t_{z+2} it will also know about the fourth wireless device WD:4. Another aspect it could be seen in the line representing t_{z+3}, here it can be seen that the third wireless device WD:3 relays the broadcast packet. Shortly after that the first wireless device will receive this relayed packet (which was caused by the first wireless device's earlier relay). Thus the first wireless device knows that the third wireless device WD:3 can hear the first wireless device WD:1. The third wireless device also remembers that it has relayed a message and should listen for future relays caused by that relay. Then finally in the row Sum (WD:2) the final state or knowledge can be shown. This knowledge is achieved after a sufficient time has passed in order for some devices to be able to draw conclusions, examples could be. Typically when a wireless device transmits a transmit packet it starts a second timer T2, the purpose of this timer is to assist in drawing conclusions on whether other wireless devices depends on the wireless device relaying broadcast packets.

Below we discuss two cases in order to help understand how the logic works.

In the first case when the first wireless device WD:1 relays the first broadcast packet BP:n it starts its second timer T2, and then after some time, but before the second timer T2 triggers, the first wireless device WD:1 receives a the relaying of the first broadcast packet BP:n made by the third wireless device WD:1. The first wireless device WD:1 thus draws the conclusion that the third wireless device WD:3 depends on the first wireless device WD:1 relaying broadcast packets sent from the device who was the originating device of the first broadcast packet BP:n.

In the second case the third wireless device WD:3 starts its second timer T2 when relaying the first broadcast packet BP:n, in this case there is no wireless device depending on the first wireless device relaying broadcast packets originated by the wireless device who was originating the first broadcast packet BP:n, thus its second timer T2 will expire without the third wireless device having received any additional relay of the first broadcast packet BP:n, and at the time when its second timer T2 triggers it can draw the conclusion that no wireless device depends on the third wireless device to relay broadcast packets under these circumstances.

Please note that each wireless device has its own second timer T2. In fact each wireless device may have several “second timers” T2i, T2i+1, etc. one for each transmission it makes, a device in the middle of a chain of devices could e.g. be relaying broadcast packets from the two sides of the chain simultaneously, thus needing several timers.

The bottom, one row, mini-table shows the aggregate knowledge if combining the knowledge from the two first tables. The last table only shows which other wireless devices are known to each wireless device, either directly or indirectly. Please note that the column that explains whether another wireless device relies on the specific wireless device to relay a broadcast packet can't be aggregated, since this information also depends on which wireless device is the originating device.

The person skilled in the art also realises that additional knowledge could be gained if receiving broadcast packets from additional originating devices (in this case the first wireless device WD:1 and the fourth wireless device WD:4). An example could be that in the aggregate table it shows that the fourth wireless device WD:4 knows about the second wireless device WD:2 and the third wireless device WD:3, but not about the first wireless device WD:1. In order for the fourth wireless device WD:4 to get knowledge about the first wireless device WD:1 the fourth wireless device WD:4 would have to receive a broadcast packet originated by the first wireless device WD:1.

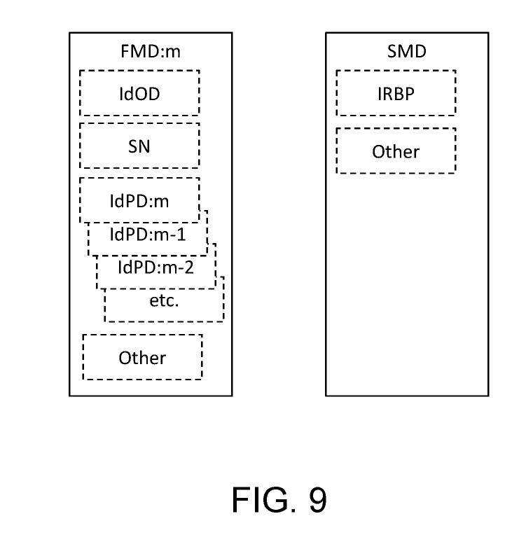

Concerning the first meta data FMD:M. In the discussion in FIGS. 3 and 4 we have assumed that the first meta data FMD:m comprises. (Please also refer to FIG. 9).
1. The Id of the originating device IdOD
2. The sequence number SN for the broadcast packet (related to the originating device) allowing the receiving devices to differentiate between different broadcast packets.
3. The Id of the immediately Preceding Device IdPD:m.

The person skilled in the art would realise that if the meta data also contained information about the Id of additional preceding devices earlier on in the path (IdPD:m−1, IdPD:m−2, etc.), the receiving devices would among other things be able to know about some intermediate devices without having to receive broadcast packets from as many originating devices. As an example if the first meta data FMD:m contained the Id of two Preceeding Devices (IdPD: m and IdPD:m−1) the fourth wireless device WD:4 would for example know about the first wireless device WD:1 when receiving a broadcast packet from the third wireless device WD:3.

Hence, the more broadcast messages for several devices received, and/or the more information provided in the First Meta Data FMD the better knowledge of the wireless ad-hoc network WAHN allowing the wireless devices to make better determinations on whether to relay broadcast packets.

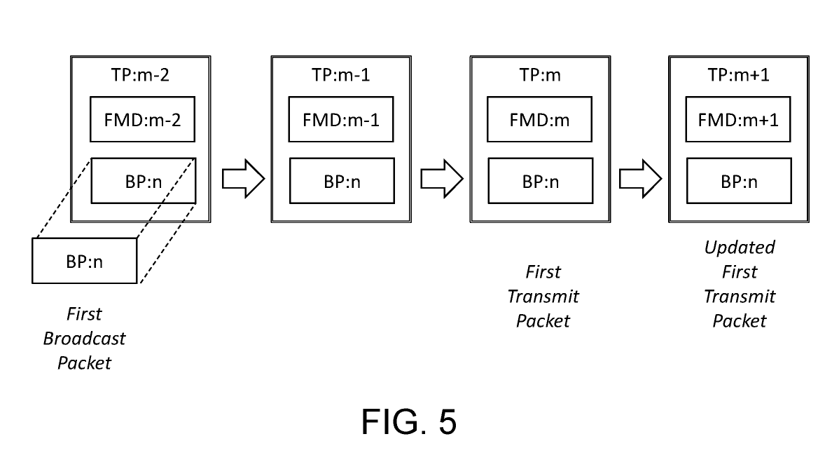

FIG. 5 depicts how the broadcast packet BP:n, is transferred throughout the network in one path in a scenario in which embodiments herein may be implemented. The purpose of the broadcasting is to transfer the broadcast packet BP to all the recipients in the network. This is done by a wireless device packaging the broadcast packet in a transmit packet TP:m−2, and transmitting it to the wireless devices within its coverage area, the wireless devices receiving this transmit packet, will determine whether to relay the broadcast packet further. A wireless device that determines to relay the broadcast packet will create a new transmit packet TP:m−1, and transmit it to wireless devices within its coverage area, and so on. The broadcast packet PB:n will always be the same in the transmit packets, the first meta data FMD however will differ, since the first meta data reflects the history up until the actual transmission by a specific wireless device.

FIG. 6 depicts a flowchart showing an example of embodiments of a method in the first wireless device WD:1, for handling a first broadcast packet BP:n. As mentioned above, the first wireless device WD:1 is operating in a wireless ad hoc network WAHN. The method comprises the following actions, which actions may be taken in any suitable order. Dashed lines of one box in FIG. 2 indicate that this action is not mandatory.

Action 601

According to an example scenario a wireless device such as the second wireless device WD:2 transmits a broadcast message intending to reach other wireless devices. Thus the first wireless device WD:1 receives a first transmit packet TP:m from the second wireless device WD:2 operating in the wireless ad hoc network WAHN. The first transmit packet TP:m comprises a first broadcast packet BP:n and a first meta data FMD:m related to the first broadcast packet BP:n. The first meta data comprises information that the first wireless device WD:1 will use in order to make decisions related to the message.

In some embodiments the first meta data FMD:m comprises any one or more of;
a. an identity IdOD of an originating device, wherein the identity identifies a wireless device WD:OD which is the origin of the first broadcast packet BP:n, and;
b. a sequence number SN, which sequence number identifies the first broadcast packet BP:n among broadcast packets originating from the originating device WD:OD, and;
c. one or more identities IdPD:m, IdPD:m−1, IdPD:m−2, etc. of preceding devices of the path of the first broadcast message BP:n, from the first wireless device WD:1 towards the originating device WD:OD, where the identity of the closest preceding device IdPD:m, IdCPD identifies the second wireless device WD:2 which is the wireless device from whom the first wireless device WD:1 directly receives the first broadcast packet BP:n.

Action 602

According to the example scenario the first wireless device WD:1 needs to determine whether or not to relay the broadcast packet to other wireless devices and to determine whether or not to decode it internally. When to do this depends on a variety of things, for example whether it is the first time a specific broadcast packet is received. Thus the first wireless device WD:1 determines based on the first meta data FMD:m, and a second meta data SMD whether the first broadcast packet BP:n shall be relayed by the first wireless device WD:1 to one or more third wireless devices WD:3 operating in the wireless ad hoc network WAHN, and/or whether the first broadcast packet BP:n shall be decoded by the first wireless device WD:1. The second meta data is related to the first broadcast packet BP:n and to the wireless ad hoc network WAHN.

In contrast to the first meta data FMD:m which is received together with the broadcast packet BP:n, the second meta data is created locally in the first wireless device WD:1 based on earlier receptions of data packets. In some embodiments the second meta data SMD comprises any one or more of;
a. An indicator IRBP, which identifies broadcast packets that has been received by the first wireless device WD:1 within a specific first time period TP1, and;
b. one or more addresses of wireless devices, from which one or more third wireless devices WD:3 have received broadcast packets originating from the originating device WD:OD after a time event TE1;
c. the number of wireless devices that can be reached by the wireless devices, from which one or more third wireless devices WD:3 have received broadcast packets originating from the originating device WD:OD after a time event TE1;
d. estimated distances from the one or more third wireless devices WD:3 to the wireless devices, from which the one or more third wireless devices WD:3 have received broadcast packets originating from the originating device WD:OD after a time event TE1;
e. estimated or stated signal strengths used by the wireless devices, from which the one or more third wireless devices WD:3 have received broadcast packets originating from the originating device WD:OD after a time event TE1.

According to some embodiments a specific broadcast packet that is transmitted from an originating wireless device may be relayed by various wireless devices and be received by one particular wireless device multiple times, in fact even the originating wireless device may receive the specific broadcast packet when relayed from another wireless devices. Typically the specific broadcast packet shall only be decoded the first time a wireless device receives it. The exception is the originating device, which typically never decode a received broadcast packet to which it was the originator. Thus, in some embodiments the first wireless device WD:1
a. determines to decode the broadcast packet BP:n when
   i. the information in the first meta data FMD:m indicates that the first wireless device WD:1 is not the originating device WD:OD, and;
   ii. the information in the first meta data FMD:m together with the information in the second meta data SMD indicates that this is the first time the first broadcast packet BP:n has been received by the first wireless device WD:1.

The determination of whether to relay the broadcast packet is done very much in line with the determination of whether to decode it. A wireless device such as the first wireless device WD:1 shall consider to relay the received specific broadcast packet if it is the first time the wireless device has received it, and the specific broadcast packet is not originated by the wireless device. But here the wireless device also has to consider a few more things when determining whether to relay the broadcast packet. First, when the wireless ad-hoc network has been operating for a while a wireless device has learned from earlier received packets whether other wireless devices depend on it to relay a broadcast packet, if this is the case the device shall relay the broadcast packet, otherwise not. Second, in addition to the above the wireless device at start up, and at other times, should try to get an understanding of the wireless ad-hoc network topology, in order to determine whether other wireless devices depend on it to relay the broadcast packet. This means that at these occasions the wireless devices such as the first wireless device WD:1 shall relay the packet both in order to relay the information as such, but also in order to be able to draw conclusions on the wireless ad-hoc network topology when receiving packets relayed from other wireless devices. The wireless device will in this way be able to detect whether new wireless devices has come within the coverage area of the wireless device and whether some other wireless devices has moved out of range. Whether an other wireless device depends on the wireless device to relay a broadcast packet also depends on who is the originator of the broadcast packet, since the broadcast packet might take different routes through the wireless ad-hoc network depending on who made the first transmission containing the broadcast packet. According to some embodiments the first wireless device WD:n
a. determines to relay the first broadcast packet BP:n to one or more third wireless devices WD:3 when;
   i. the information in the first meta data FMD:m indicates that the first wireless device WD:1 is not the originating device WD:OD, and;
   ii. the information in the first meta data FMD:m together with the information in the second meta data SMD indicates that this is the first time the first broadcast packet BP:n is received by the first wireless device WD:1, and any of;
   iii. the information in the first meta data FMD:n together with the information in the second meta data SMD indicates that one or more third wireless devices WD:3 depends on the first wireless device WD:1 relaying the first broadcast packet BP:n, or;
   iv. the information in the first meta data FMD:m together with the information in the second meta data SMD indicates that this is the first time a broadcast packet from the originating device WD:OD is received by the first wireless device WD:1 after a time event TE1.

Further, other devices may depend on the a specific wireless devices to relay the broadcast packet for various reasons, one is that the wireless device is the only one who can reach one or more devices, another is that it is the preferred relaying wireless device out of more than one that are able to reach the other wireless devices. According to some embodiments the indication that one or more third wireless devices WD:3 depends on the first wireless device WD:1 relaying the first broadcast packet PB:n is any of;
a. the information in the first meta data FMD:m together with the information in the second meta data SMD indicates that one or more third devices WD:3 after a time event TE1 has so far only been able to receive broadcast packets originating from the originating device WD:OD via the first wireless device WD:1;
b. the information in the first meta data FMD together with the information in the second meta data SMD indicates that one or more third wireless devices WD:3 are in radio coverage of multiple wireless devices but that it is preferable that the first wireless device WD:1 acts as relay to the one or more third wireless devices WD:3 for packets coming originally from the originating device WD:OD.

A wireless device may be the preferred relaying device for a variety of reasons, According to some embodiments the indication that it is preferable that the first wireless device acts as relay is any one or more of;
a. a comparison of addresses of wireless devices, from which the one or more third wireless devices WD:3 have received broadcast packets originating from the originating device WD:OD after a time event TE1 indicates that the first wireless device WD:1 shall act as relay;
b. a comparison of the number of wireless devices that can be reached by the wireless devices, from which the one or more third wireless devices WD:3 have received broadcast packets originating from the originating device WD:OD after a time event TE1 indicates that the first wireless device WD:1 shall act as relay;
c. a comparison of estimated distances from the one or more third wireless devices WD:3 to the wireless devices, from which the one or more third wireless devices WD:3 have received broadcast packets originating from the originating device WD:OD after a time event TE1 indicates that the first wireless device WD:1 shall act as relay;
d. a comparison of estimated or stated signal strengths used by the wireless devices, from which the one or more third wireless devices WD:3 have received broadcast packets originating from the originating device WD:OD after a time event TE1 indicates that the first wireless device WD:1 shall act as relay.

Action 603

According to the example scenario the first wireless device WD:1 will relay the broadcast packet to other wireless devices, this is done by first creating an updated transmit packet which comprises the broadcast packet plus updated meta data, and then transmitting the transmit packet. Thus according to some embodiments,
a. The first wireless device WD:1 relays the first broadcast packet PB:n, by;
   i. creating an updated first transmit packet TP m+1 consisting of the first broadcast packet BP:n and updated first meta data FMD:m+1, where the updated first meta data FMD:m+1 is partly based on the first meta data FMD:m, and;
   ii. transmitting the updated first transmit TP m+1 packet.

According to some embodiments the transmission of the transmit packet will be done after a random delay in order to minimise the risk of collisions. Assume that two or more wireless devices has received the broadcast packet and that two or more of them have determined to relay the broadcast packet. In this scenario it is desirable that they do not transmit at the same time. Thus the first wireless device WD:1 transmits the updated first transmit packet TP:m+1 by further performing one of;
a. transmitting the updated first transmit packet after a delay based on pseudo random numbers;
b. transmitting the updated first transmit packet after a delay selected from a set of delay values;
c. transmitting the updated first transmit packet after a delay based on the randomization of the address of the first wireless device WD:1;
d. transmitting the updated first transmit packet after a delay based on the path loss from the previous transmitting wireless device.

The text below relates to any suitable embodiment above.

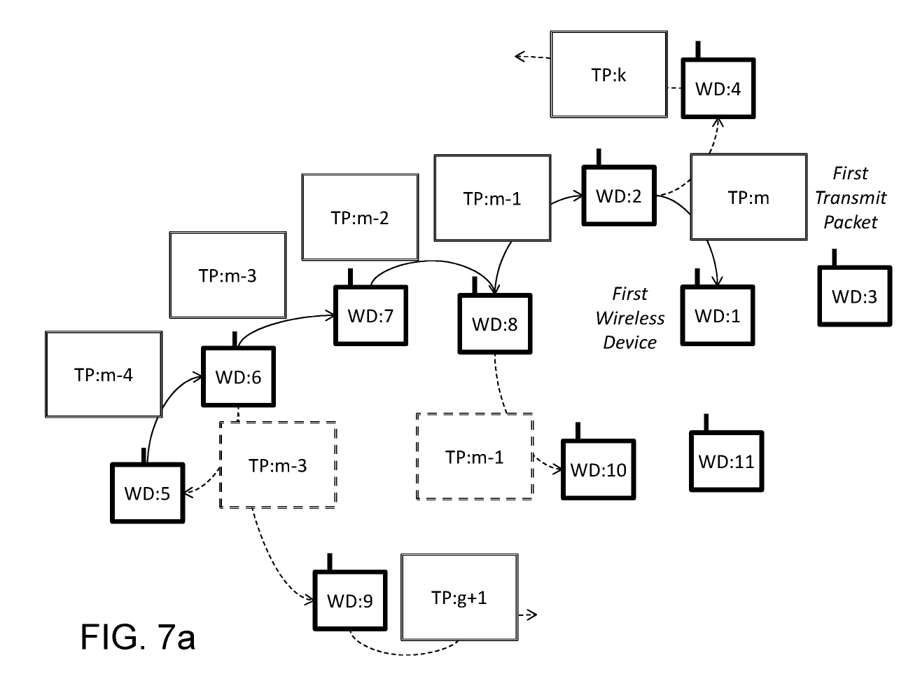

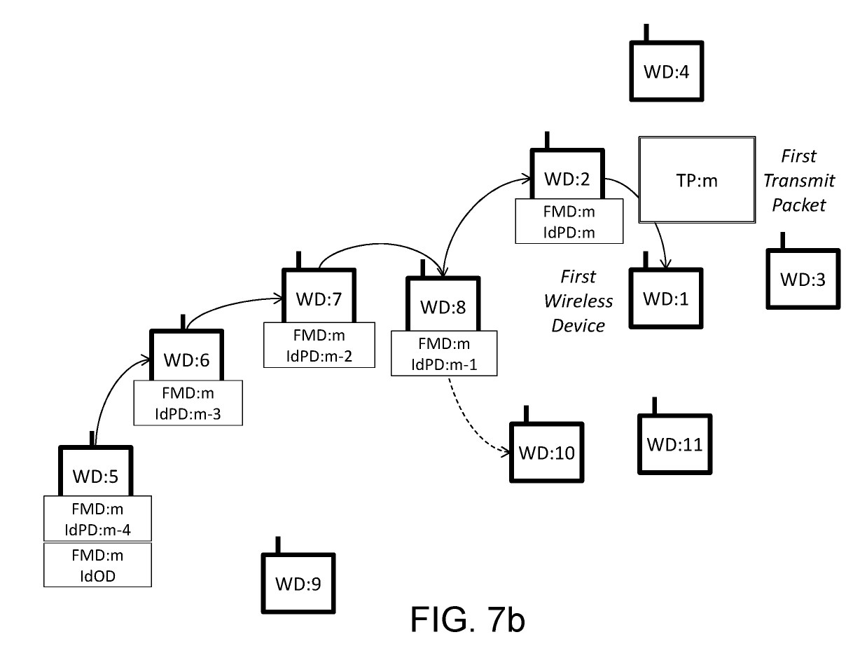

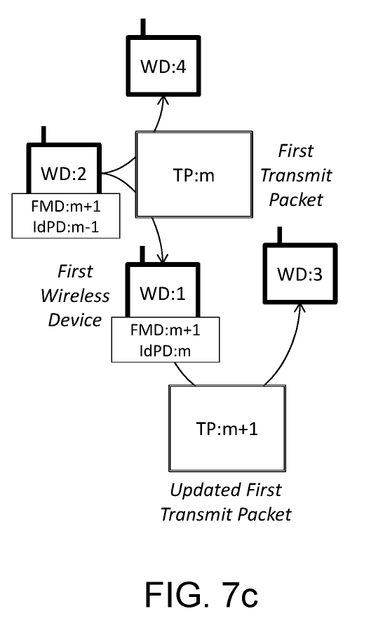

FIG. 7 (a and b) depicts eleven wireless devices WD:1, WD:2 . . . WD:11 that can be said to participate in a wireless ad-hoc network WAHN. The figures outline one possible path that a broadcast packet BP:n can take from an originating device to a selected receiving device.

In order to more pedagogically fit the description of FIGS. 1 and 3, the four wireless devices WD:1, WD:2, WD:3 and WD:4 are put in the rightmost part of FIG. 7. The fifth wireless device WD:5 is chosen as the originating device and the first wireless device WD:1 is the selected receiving device.

The text related to FIGS. 6 (a and b) will focus on the following situation:
1. The first wireless device WD:1 receiving a first transmit packet TP:m from the second wireless device WD:2.
2. The first transmit packet comprises
   a. a first broadcast packet BP:n, and
   b. a first meta data FMD:m related to the first broadcast packet BP:n.
3. The first broadcast packet being originated by the fifth wireless device WD:5.
4. The first broadcast packet having taken the specific path (the first path) outlined in FIGS. 7a and 7b.

In order not to make FIGS. 7a and 7b overly complicated, the coverage areas for the different wireless devices are not shown explicitly. Instead one has to imagine that the coverage areas are more or less circular and reach to the closest wireless device/devices. This mean that the broadcast packet BP:n can't be sent directly from the fifth wireless device WD:5 to the first wireless device WD:1. Instead the broadcast packet BP:n has to be relayed by the wireless devices in between.

FIG. 7a focus on the broadcast packet BP:n being transferred in in the various depicted transmit packets, and even though FIG. 7a does not explicitly shows all recipients of all depicted transmit packets, it is intended to provide sufficient background for such a discussion as well.

FIG. 7b focus on showing some values of the first meta data FMD:m which is carried inside the first transmit packet TP:m. The primary aim is to show that the first meta data outlines the originating device and all or parts of the path. In some embodiments herein only the identity of the immediately preceding device IdPD:m is indicated in the First Meta Data FMD, in other embodiments herein the identity of multiple preceding devices could be carried in the first meta data FDM, providing information on more of the path, or possibly all the path.

As mentioned above FIGS. 7a and 7b focus on the situation where the first wireless device WD:1 relays in order to make sure that the third wireless device WD:3 will receive the broadcast packet PB:n. If one for a moment imagine that the third wireless device WD:3 is the originator, the reason for the first wireless device to relay would be to make sure that the second wireless device WD:2 and the eleventh wireless device WD:11 would be reached, and through them the rest of the wireless devices. One can also imagine a situation where a wireless device relays packets from one specific originator, while it does not relay packets from another specific originator.

FIG. 7c provides an overview of how the first wireless device will relay the broadcast packet in order to reach the third wireless device WD:3. Showing mainly that the transmit packet transmitted by the first wireless device WD:1 is not the same as the transmit packet transmitted by the second wireless device WD:2, now the First Meta Data is updated, the figure illustrates that the IdPD fields (identity of preceding devices) are changed.

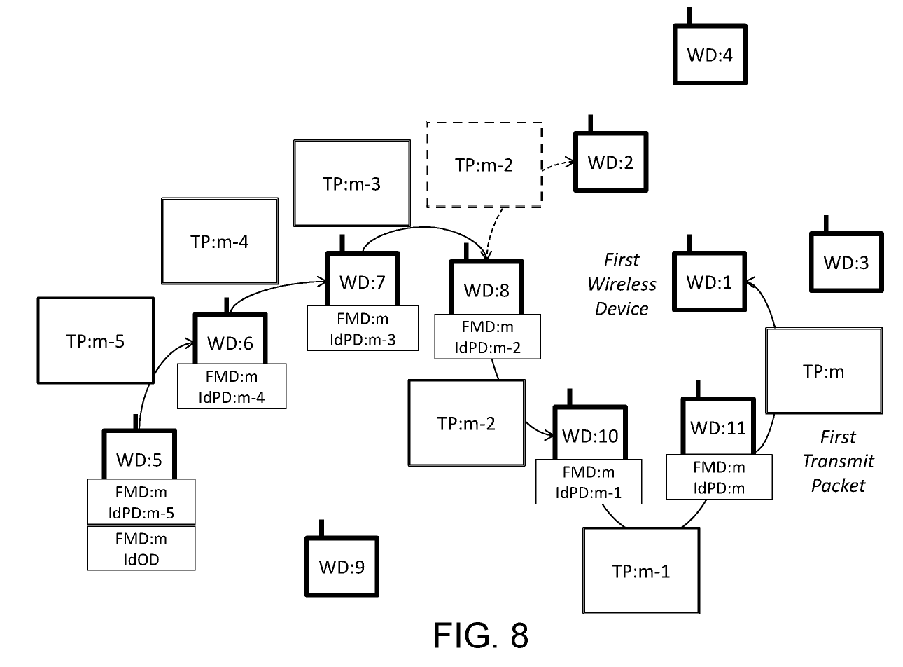

Another thing not explicitly shown in neither FIG. 7a nor FIG. 8, but should be emphasized is that the relaying made by the first wireless device WD:1 could be received not only by the third wireless device WD:3 but also by the second wireless device WD:2 and the eleventh wireless device WD:11.

FIG. 8 provides an overview of a second path through the wireless ad-hoc network. In this second path the broadcast packet is relayed from the eighth wireless device WD:8 to the first wireless device WD:1, via the tenth and eleventh wireless devices WD:10 and WD:11.

This picture illustrates a couple of important things. One important thing is that each transmit packet that is received will be treated as the “first transmit packet”, meaning the transmit packet that is to be analyzed and possibly decoded and forwarded. In FIG. 7a the “first transmit packet” is transmitted by the second wireless device WD:2, while in FIG. 8 “the first transmit packet” is transmitted from the eleventh wireless device WD:11. The first wireless device WD:1 will of course use the same logic to determine what to do when receiving a “first transmit packet”.

Another aspect is illustrated (when comparing with FIGS. 7a, 7b and 7c) is that the broadcast packet that is carried inside the “first transmit packets” are the same. Meaning that it will only be relayed once by the first wireless device WD:1.

A third aspect that is illustrated is that some fields in the “first meta data” (meaning the meta data carried inside the “first transmit packets”) are different. One example could be that in picture 7b, the IdPD:m−1 (the identity of the preceding device two steps before the first wireless device) would point at the eighth wireless device WD:1. While in FIG. 8 IdPDm−2 (indicating three steps before the first wireless device) would point at the eight wireless device WD:1. Thus allowing the first wireless device WD:1 to build up knowledge about the various devices in the wireless ad-hoc network.

FIG. 8 also aims at clarifying the discussion of an interesting question. Namely how a wireless device can find out if another wireless device could depend on the wireless device or some other wireless device to relay broadcast packets from a specific originator. Or to express it differently, how it can find out if another wireless device can hear a relay transmission of broadcast packets originating from a certain originating device, from more wireless devices than itself.

A related question is how to select which wireless device then should relay the broadcast packets originated by that specific originating device. And since all wireless devices takes its own decisions this boils down to how a wireless device in this situation could decide when it shall relay and when it shall not. Thus also trusting that the other wireless devices that could be potential relays, do the opposite, in order to guarantee that the other wireless device will always receive the broadcast packets from the originating device, but yet that no unnecessary relaying is done.

Let's first take a look at the first question above. In order to exemplify this situation we refer to FIGS. 7a, 7c and 8, and focus on the three wireless devices WD:2, WD: 1 and WD:1. FIG. 7a shows that WD:1 can receive the broadcast packet relayed by WD:2. FIG. 7c shows how WD:1 relays the broadcast packet further, it is not explicitly shown in the figure (due to lack of space not wanting to make the picture overly complicated), but one can assume that WD:2 will receive the relaying made by WD:1, thus understanding that WD:1 could depend on WD:2 relaying broadcast packets from the originator of the specific broadcast packet. FIG. 8 then shows that WD:1 also receives the relay of the broadcast packets sent from WD:11.

In some embodiments herein, each wireless device only relays the broadcast packet the first time it is received, in these embodiment the WD:2 will hear the relaying made by WD:1 caused by receiving the relaying made by WD:2. WD:1 will not relay the relaying it received from WD:11. Thus WD:2 will understand that WD:1 depends on WD:2 under these circumstances, and WD:11 will not receive a relaying caused by the relaying ED:11 itself made and it will not draw the conclusion that WD:1 depends on WD:11. (WD:11 will in this case most likely a short while after receive the relaying made by WD:1 caused by the relaying it received from WD:2.

It could be potentially beneficial if WD:2 and WD:11 in the example above would have known that there would be alternative ways to reach WD:1, this information could be used in many ways. One could for example make the decisions as made in the example above, but be aware that there would be an alternative way that could be used in the case the first path (via WD:2) would not work anymore due to e.g. that WD:2 moves and goes out of coverage. Another example could be to choose WD:11 as the preferred path to reach WD:1 rather than WD:2.

In order to take the decision to choose another path, first the wireless devices would have to know that alternative paths exist, when the knowledge is established a decision could be made based on that knowledge.

In one embodiment herein each wireless device will relay all received relaying of the broadcast packet that is first to be received after time event TE1, from each originator. This would cause some extra relaying initially but would spread the information about alternative paths. In another embodiments herein each wireless device would send additional information in the first meta data, e.g. sending reports on that it can be reached by different paths when receiving relays of broadcast packets from a certain originator, it can also tell radio related parameters for the paths, for example the perceived distances or perceived transmit powers (or other parameters, like which relaying was received first in time, the addresses of the wireless devices, the number of steps in the path from the originating device, the number of devices that can hear further relaying, etc. etc.) used by the wireless devices it can hear, the wireless devices could in fact inform about the real transmit power that was used by the wireless devices it could hear (if the transmitting wireless devices would include that information in the first meta data of their transmission). In both of these embodiments the involved wireless devices would after some time be aware of the alternative paths, and also be aware that the other devices would be aware.

If now taking a look at the second question how to decide which wireless device shall relay broadcast packets from. Here it is important that the wireless devices representing the alternative paths use the same logic to make the decisions and base the decision on the same parameters, in order to make sure that one path is chosen and not two (or no path at all). In some embodiments herein such a decision could be based on the time of reception, e.g. the path where the first relaying was received could be chose. In some other embodiments the address of the wireless devices could be used, e.g. the device with the lowest/highest address could be chosen as the relaying device. In some embodiments the device that has the lowest/highest number of nodes in the path from the originating device could be chosen as the relaying node. In some embodiments the decision on which device should relay could be based on the transmission power, Etc. In some embodiments the received signal strength could be used when determining which wireless device should relay. In yet some other embodiments the estimated/determined distances to the wireless devices that are potential relays could be used when determining which wireless device should relay, here one should take into account that it might be better in some cases that a wireless device that is closer to the target performs the relay since in that case the coverage would be extended.

In some embodiments, if the distance between a wireless device that is a potential relay and the wireless device that is the target is larger than a first threshold, the wireless device that is the potential relay should act as a relay. Hence if the wireless device that is the potential relay is very close to the target, the coverage increase by relaying is marginal and therefore in order to reduce the interference risk the wireless device that is the potential relay decides to not relay the message, even though the message have not been received before.

FIG. 9 is an overview of First Meta Data and Second Meta Data. Metadata (or meta contents) are generally defined as the data providing information about one or more aspects of the data, such as:

Means of creation of the data

Purpose of the data

Time and date of creation

Creator or author of the data

Location on a computer network where the data were created

Standards used

In this application the First Meta Data FMD is carried in the Transmit Packet TP, together with the Broadcast Packet BP, while the Second Meta Data SMD is kept locally in each wireless device.

The First Meta Data may in some embodiments contain some or all of the contents described below:
an identity (IdOD) of an originating device, wherein the identity identifies a wireless device (WD:OD) which is the origin of the first broadcast packet (BP:n)
a sequence number (SN), which sequence number identifies the first broadcast packet (BP:n) among broadcast packets originating from the originating device (WD:OD)
one or more identities (IdPD:m, IdPD:m−1, IdPD:m−2, etc.) of preceding devices of the path of the first broadcast message (BP:n), from the first wireless device (WD:1) towards the originating device (WD:OD), where the identity of the closest preceding device (IdPD:m, IdCPD) identifies the second wireless device (WD:2) which is the wireless device from whom the first wireless device (WD:1) directly receives the first broadcast packet (BP:n)
Other values like e.g.
   Transmission power used when transmitting the transmit packet.
   Information related to other wireless devices that the wireless device can hear concerning broadcast packets from a certain originator, such as:
      Number of
      identities
      hardware or other low level addresses
      reception times of transmit packets
      Link metric such as Received Signal Strength Indicator RSSI), or Pilot power, RSRP
      Total metric path from source
      estimated transmit power used by the other wireless devices.
      estimated distance to the other wireless devices

The Second Meta Data may in some embodiments contain some or all of the contents described below:
An indicator (IRBP), which identifies broadcast packets that has been received by the first wireless device (WD:1) within a specific first time period (TP1)
Other values like:
   one or more addresses of wireless devices, from which one or more third wireless devices (WD:3) have received broadcast packets originating from the originating device (WD:OD) after a time event (TE1)
   the number of wireless devices that can be reached by the wireless devices, from which one or more third wireless devices (WD:3) have received broadcast packets originating from the originating device (WD:OD) after a time event (TE1)
   estimated distances from the one or more third wireless devices (WD:3) to the wireless devices, from which the one or more third wireless devices (WD:3) have received broadcast packets originating from the originating device (WD:OD) after a time event (TE1)
   estimated or stated signal strengths used by the wireless devices, from which the one or more third wireless devices (WD:3) have received broadcast packets originating from the originating device (WD:OD) after a time event (TE1)

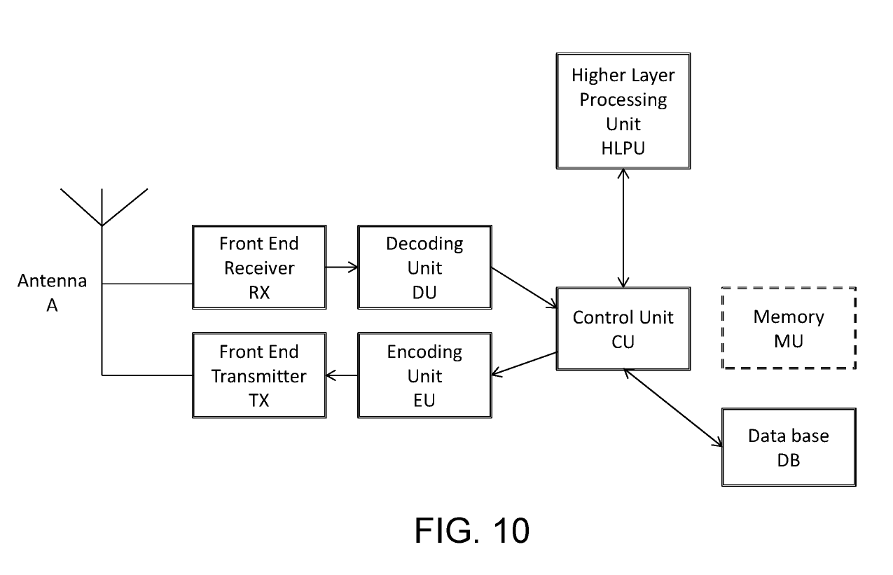

FIG. 10 depicts a block diagram over a first wireless device WD:1 operating according to the invention.

The first wireless device is configured to, e.g. by means of an Antenna A, that receives and transmits radio signals.

The first wireless device is further configured to, e.g. by means of a Front End Receiver RX, converting the radio signal to a digital baseband signal.

The first wireless device is further configured to, e.g. by means of a Decoding Unit DU, do the low layer decoding of the received signal.

The first wireless device is further configured to, e.g. by means of a Control Unit CU, decide whether the signal should be decoded (e.g. by a higher layer processing unit HLPU) or not, and whether the message should be relayed or not.

The first wireless device is further configured to, e.g. by means of a Higher Layer Processing Unit HLPU to (optionally decode and) make use of decoded data.

The first wireless device is further configured to, e.g. by means of a data base DB, keep track of information (e.g. including information about earlier received messages transmitter IDs, relay IDs, estimated distance to respective devices, message sequence number received etc.), referred to as the First Meta Data FMD, and the Second Meta Data SMD, that will help in making the determinations on whether to decode or not and/or whether to relay or not.

The wireless device may further comprise a memory M, comprising one or more memory units. The memory M is arranged to be used to store obtained information. The Data Base DB may be stored in the memory M or separate.

The first wireless device is further configured to, e.g. by means of a Encoding Unit EU, encoding the signal that is to be sent.

The first wireless device is further configured to, e.g. by means of a Front End Transmitter TX, transforming the encoded baseband signal into a radio signal, which is then transmitted via an antenna.

To perform the method actions for handling a broadcast packet in a wireless device in a wireless ad-hoc network described above, the wireless device further comprises the following arrangements.

A first wireless device WD:1, for handling a first broadcast packet BP:n which first wireless device WD:1 is configured to operate in a wireless ad hoc network WAHN, the first wireless device is configured to:

receive a first transmit packet TP:m from a second wireless device WD:2 operating in the wireless ad hoc network WAHN, wherein the first transmit packet TP:m comprises a first broadcast packet BP:n and a first meta data FMD:m related to the first broadcast packet BP:n,

determine based on the first meta data FMD:m, and a second meta data SMD whether the first broadcast packet BP:n shall be relayed by the first wireless device WD:1 to one or more third wireless devices WD:3 operating in the wireless ad hoc network WAHN, and/or whether the first broadcast packet BP:n shall be decoded by the first wireless device WD:1; wherein the second meta data is related to the first broadcast packet BP:n and to the wireless ad hoc network WAHN.

The first wireless device WD:1 of, wherein the first meta data FMD:m comprises any one or more of;

a. an identity IdOD of an originating device, wherein the identity identifies a wireless device WD:OD which is the origin of the first broadcast packet BP:n, and;

b. a sequence number SN, which sequence number identifies the first broadcast packet BP:n among broadcast packets originating from the originating device WD:OD, and;

c. one or more identities IdPD:m, IdPD:m−1, IdPD:m−2, etc. of preceding devices of the path of the first broadcast message BP:n, from the first wireless device WD:1 towards the originating device WD:OD, where the identity of the closest preceding device IdPD:m, IdCPD identifies the second wireless device WD:2 which is the wireless device from whom the first wireless device WD:1 directly receives the first broadcast packet BP:n.

The first wireless device WD:1, wherein the second meta data SMD comprises any one or more of;

a. An indicator IRBP, which identifies broadcast packets that has been received by the first wireless device WD:1 within a specific first time period TP1, and;

b. one or more addresses of wireless devices, from which one or more third wireless devices WD:3 have received broadcast packets originating from the originating device WD:OD after a time event TE1;

c. the number of wireless devices that can be reached by the wireless devices, from which one or more third wireless devices WD:3 have received broadcast packets originating from the originating device WD:OD after a time event TE1;

d. estimated distances from the one or more third wireless devices WD:3 to the wireless devices, from which the one or more third wireless devices WD:3 have received broadcast packets originating from the originating device WD:OD after a time event TE1;

e. estimated or stated signal strengths used by the wireless devices, from which the one or more third wireless devices WD:3 have received broadcast packets originating from the originating device WD:OD after a time event TE1;

The first wireless device WD:1, further being configured to determine whether the broadcast packet BP:n shall be decoded by the first wireless device WD:1 by:

a. determining to decode when

i. the information in the first meta data FMD:m indicates that the first wireless device

WD:1 is not the originating device WD:OD, and;

ii. the information in the first meta data FMD:m together with the information in the second meta data SMD indicates that this is the first time the first broadcast packet BP:n has been received by the first wireless device WD:1.

The first wireless device WD:1, further being configured to determine whether the first broadcast packet BP:n shall be relayed by the first wireless device WD:n to one or more third wireless devices WD:3 by;

b. determining to relay the first broadcast packet BP:n when;

i. the information in the first meta data FMD:m indicates that the first wireless device WD:1 is not the originating device WD:OD, and;

ii. the information in the first meta data FMD:m together with the information in the second meta data SMD indicates that this is the first time the first broadcast packet BP:n is received by the first wireless device WD:1, and any of;

iii. the information in the first meta data FMD:n together with the information in the second meta data SMD indicates that one or more third wireless devices WD:3 depends on the first wireless device WD:1 relaying the first broadcast packet BP:n, or;

iv. the information in the first meta data FMD:m together with the information in the second meta data SMD indicates that this is the first time a broadcast packet from the originating device WD:OD is received by the first wireless device WD:1 after a time event TE1.

The first wireless device WD:1, where the indication that one or more third wireless devices WD:3 depends on the first wireless device WD:1 relaying the first broadcast packet PB:n is any of;

a. the information in the first meta data FMD:m together with the information in the second meta data SMD indicates that one or more third devices WD:3 after a time event TE1 has so far only been able to receive broadcast packets originating from the originating device WD:OD via the first wireless device WD:1;

b. the information in the first meta data FMD together with the information in the second meta data SMD indicates that one or more third wireless devices WD:3 are in radio coverage of multiple wireless devices but that it is preferable that the first wireless device WD:1 acts as relay to the one or more third wireless devices WD:3 for packets coming originally from the originating device WD:OD.

The first wireless device WD:1, where the indication that it is preferable that the first wireless device acts as relay is any one or more of;

e. a comparison of addresses of wireless devices, from which the one or more third wireless devices WD:3 have received broadcast packets originating from the originating device WD:OD after a time event TE1 indicates that the first wireless device WD:1 shall act as relay;

f. a comparison of the number of wireless devices that can be reached by the wireless devices, from which the one or more third wireless devices WD:3 have received broadcast packets originating from the originating device WD:OD after a time event TE1 indicates that the first wireless device WD:1 shall act as relay;

g. a comparison of estimated distances from the one or more third wireless devices WD:3 to the wireless devices, from which the one or more third wireless devices WD:3 have received broadcast packets originating from the originating device WD:OD after a time event TE1 indicates that the first wireless device WD:1 shall act as relay;

h. a comparison of estimated or stated signal strengths used by the wireless devices, from which the one or more third wireless devices WD:3 have received broadcast packets originating from the originating device WD:OD after a time event TE1 indicates that the first wireless device WD:1 shall act as relay.

The first wireless device WD:1, further being configured to;

a. Relaying the first broadcast packet PB:n by;

i. creating an updated first transmit packet TP m+1 consisting of the first broadcast packet BP:n and updated first meta data FMD:m+1, where the updated first meta data FMD:m+1 is partly based on the first meta data FMD:m, and;

ii. transmitting the updated first transmit TP m+1 packet;

The first wireless device WD:1, further being configured to transmit the updated first transmit packet by any one out of;

e. transmitting the updated first transmit packet after a delay based on pseudo random numbers;

f. transmitting the updated first transmit packet after a delay selected from a set of delay values;

g. transmitting the updated first transmit packet after a delay based on the randomization of the address of the first wireless device WD:1);

h. transmitting the updated first transmit packet after a delay based on the path loss from the previous transmitting wireless device;

The embodiments herein for handling a broadcast packet in a first wireless device WD:1 may be implemented through one or more control units, such as a control unit CU, together with computer program code for performing the functions and actions of the embodiments herein. The program code mentioned above may also be provided as a computer program product, for instance in the form of a data carrier carrying computer program code for performing the embodiments herein when being loaded into the in the first wireless device WD:1. One such carrier may be in the form of a CD ROM disc. It is however feasible with other data carriers such as a memory stick. The computer program code may furthermore be provided as pure program code on a server and downloaded to the first wireless device WD:1 at production, and/or during software updates.

Those skilled in the art will also appreciate that the blocks in the block diagram in FIG. 4, may refer to a combination of analog and digital circuits, and/or one or more processors configured with software and/or firmware, e.g. stored in the memory M, that when executed by the one or more processors such as the processor CU perform as described above. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

1. A method in a first wireless device, for handling a first broadcast packet which first wireless device is operating in a wireless ad hoc network, the method comprising:
receiving a first transmit packet from a second wireless device operating in the wireless ad hoc network, wherein the first transmit packet comprises a first broadcast packet and a first meta data related to the first broadcast packet, and
determining based on the first meta data, and a second meta data whether the first broadcast packet shall be relayed by the first wireless device to one or more third wireless devices operating in the wireless ad hoc network, and/or whether the first broadcast packet shall be decoded by the first wireless device; wherein the second meta data is related to the first broadcast packet and to the wireless ad hoc network.

2. The method of claim 1, wherein the first meta data comprises any one or more of:
a. an identity of an originating device, wherein the identity identifies a wireless device which is the origin of the first broadcast packet, and;
b. a sequence number, which sequence number identifies the first broadcast packet among broadcast packets originating from the originating device, and;
c. one or more identities of preceding devices of the path of the first broadcast message, from the first wireless device towards the originating device, where the identity of the closest preceding device identifies the second wireless device which is the wireless device from whom the first wireless device directly receives the first broadcast packet.

3. The method of claim 1, wherein the second meta data comprises any one or of:
a. An indicator, which identifies broadcast packets that has been received by the first wireless device within a specific first time period, and;
b. one or more addresses of wireless devices, from which one or more third wireless devices have received broadcast packets originating from the originating device after a time event;
c. the number of wireless devices that can be reached by the wireless devices, from which one or more third wireless devices have received broadcast packets originating from the originating device after a time event;
d. estimated distances from the one or more third wireless devices to the wireless devices, from which the one or more third wireless devices have received broadcast packets originating from the originating device after a time event;
e. estimated or stated signal strengths used by the wireless devices, from which the one or more third wireless devices have received broadcast packets originating from the originating device after a time event;

4. The method of claim 2, wherein determining whether the broadcast packet shall be decoded by the first wireless device comprises:
a. determining to decode when
b. the information in the first meta data indicates that the first wireless device is not the originating device, and;
c. the information in the first meta data together with the information in the second meta data indicates that this is the first time the first broadcast packet has been received by the first wireless device.

5. The method of claim 1, where determining whether the first broadcast packet shall be relayed by the first wireless device to one or more third wireless devices comprises;
a. determining to relay the first broadcast packet when:
i. the information in the first meta data indicates that the first wireless device is not the originating device, and;
ii. the information in the first meta data together with the information in the second meta data indicates that this is the first time the first broadcast packet is received by the first wireless device, and any of:
iii. the information in the first meta data together with the information in the second meta data indicates that one or more third wireless devices depends on the first wireless device relaying the first broadcast packet, or;
iv. the information in the first meta data together with the information in the second meta data indicates that this is the first time a broadcast packet from the originating device is received by the first wireless device after a time event.

6. The method of claim 5, where the indication that one or more third wireless devices depends on the first wireless device relaying the first broadcast packet is any of:
a. the information in the first meta data together with the information in the second meta data indicates that one or more third devices after a time event has so far only been able to receive broadcast packets originating from the originating device via the first wireless device;
b. the information in the first meta data together with the information in the second meta data indicates that one or more third wireless devices are in radio coverage of multiple wireless devices but that it is preferable that the first wireless device acts as relay to the one or more third wireless devices for packets coming originally from the originating device.

7. The method of claim 6, where the indication that it is preferable that the first wireless device acts as relay is any one or more of:
a. a comparison of addresses of wireless devices, from which the one or more third wireless devices have received broadcast packets originating from the originating device after a time event indicates that the first wireless device shall act as relay;
b. a comparison of the number of wireless devices that can be reached by the wireless devices, from which the one or more third wireless devices have received broadcast packets originating from the originating device after a time event indicates that the first wireless device shall act as relay;
c. a comparison of estimated distances from the one or more third wireless devices to the wireless devices, from which the one or more third wireless devices have received broadcast packets originating from the originating device after a time event indicates that the first wireless device shall act as relay;
d. a comparison of estimated or stated signal strengths used by the wireless devices, from which the one or more third wireless devices have received broadcast packets originating from the originating device after a time event indicates that the first wireless device shall act as relay;

8. The method of claim 1, further comprising;
a. relaying the first broadcast packet, which relaying is performed by:
i. creating an updated first transmit packet consisting of the first broadcast packet and updated first meta data, where the updated first meta data is partly based on the first meta data, and;
ii. transmitting the updated first transmit packet;

9. The method of claim 8 where transmitting the updated first transmit packet further comprises one of;
a. transmitting the updated first transmit packet after a delay based on pseudo random numbers;
b. transmitting the updated first transmit packet after a delay selected from a set of delay values;
c. transmitting the updated first transmit packet after a delay based on the randomization of the address of the first wireless device;
d. transmitting the updated first transmit packet after a delay based on the path loss from the previous transmitting wireless device.

10. A first wireless device, for handling a first broadcast packet which first wireless device is configured to operate in a wireless ad hoc network, the first wireless device is configured to:
receive a first transmit packet from a second wireless device operating in the wireless ad hoc network, wherein the first transmit packet comprises a first broadcast packet and a first meta data related to the first broadcast packet, and
determine based on the first meta data, and a second meta data whether the first broadcast packet shall be relayed by the first wireless device to one or more third wireless devices operating in the wireless ad hoc network, and/or whether the first broadcast packet shall be decoded by the first wireless device; wherein the second meta data is related to the first broadcast packet and to the wireless ad hoc network.

11. The first wireless device of claim 10, wherein the first meta data comprises any one or more of:
a. an identity of an originating device, wherein the identity identifies a wireless device which is the origin of the first broadcast packet, and;
b. a sequence number, which sequence number identifies the first broadcast packet among broadcast packets originating from the originating device, and;
c. one or more identities of preceding devices of the path of the first broadcast message, from the first wireless device towards the originating device, where the identity of the closest preceding device identifies the second wireless device which is the wireless device from whom the first wireless device directly receives the first broadcast packet.

12. The first wireless device of claim 10, wherein the second meta data comprises any one or more of:
a. an indicator, which identifies broadcast packets that has been received by the first wireless device within a specific first time period, and;
b. one or more addresses of wireless devices, from which one or more third wireless devices have received broadcast packets originating from the originating device after a time event;
c. the number of wireless devices that can be reached by the wireless devices, from which one or more third wireless devices have received broadcast packets originating from the originating device after a time event;
d. estimated distances from the one or more third wireless devices to the wireless devices, from which the one or more third wireless devices have received broadcast packets originating from the originating device after a time event;
e. estimated or stated signal strengths used by the wireless devices, from which the one or more third wireless devices have received broadcast packets originating from the originating device after a time event.

13. The first wireless device of claim 10, further being configured to determine whether the broadcast packet shall be decoded by the first wireless device by:
a. determining to decode when
i. the information in the first meta data indicates that the first wireless device is not the originating device, and;
ii. the information in the first meta data together with the information in the second meta data indicates that this is the first time the first broadcast packet has been received by the first wireless device.

14. The first wireless device of claim 10, further being configured to determine whether the first broadcast packet shall be relayed by the first wireless device to one or more third wireless devices by:
a. determining to relay the first broadcast packet when:
i. the information in the first meta data indicates that the first wireless device is not the originating device, and;
ii. the information in the first meta data together with the information in the second meta data indicates that this is the first time the first broadcast packet is received by the first wireless device, and any of:
iii. the information in the first meta data together with the information in the second meta data indicates that one or more third wireless devices depends on the first wireless device relaying the first broadcast packet, or;
iv. the information in the first meta data together with the information in the second meta data indicates that this is the first time a broadcast packet from the originating device is received by the first wireless device after a time event.

15. The first wireless device of claim 14, where the indication that one or more third wireless devices depends on the first wireless device relaying the first broadcast packet is any of:
a. the information in the first meta data together with the information in the second meta data indicates that one or more third devices after a time event has so far only been able to receive broadcast packets originating from the originating device via the first wireless device;
b. the information in the first meta data together with the information in the second meta data indicates that one or more third wireless devices are in radio coverage of multiple wireless devices but that it is preferable that the first wireless device acts as relay to the one or more third wireless devices for packets coming originally from the originating device.

16. The first wireless device of claim 15, where the indication that it is preferable that the first wireless device acts as relay is any one or more of:
a. a comparison of addresses of wireless devices, from which the one or more third wireless devices have received broadcast packets originating from the originating device after a time event indicates that the first wireless device shall act as relay;
b. a comparison of the number of wireless devices that can be reached by the wireless devices, from which the one or more third wireless devices have received broadcast packets originating from the originating device after a time event indicates that the first wireless device shall act as relay;
c. a comparison of estimated distances from the one or more third wireless devices to the wireless devices, from which the one or more third wireless devices have received broadcast packets originating from the originating device after a time event indicates that the first wireless device shall act as relay;
d. a comparison of estimated or stated signal strengths used by the wireless devices, from which the one or more third wireless devices have received broadcast packets originating from the originating device after a time event indicates that the first wireless device shall act as relay.

17. The first wireless device of claim 10, further being configured to:
a. relay the first broadcast packet by:
i. creating an updated first transmit packet consisting of the first broadcast packet and updated first meta data, where the updated first meta data is partly based on the first meta data, and;
ii. transmitting the updated first transmit packet.

18. The first wireless device of claim 17, further being configured to transmit the updated first transmit packet by any one out of:
a. transmitting the updated first transmit packet after a delay based on pseudo random numbers;
b. transmitting the updated first transmit packet after a delay selected from a set of delay values;
c. transmitting the updated first transmit packet after a delay based on the randomization of the address of the first wireless device;
d. transmitting the updated first transmit packet after a delay based on the path loss from the previous transmitting wireless device.
